(19) United States
(12) Patent Application Publication
(10) Pub. No.: US 2026/0280000 A1
(43) Pub. Date: Sep. 17, 2026

(54) BATTERY PACK ADAPTOR

(71) Applicant: Black & Decker Inc., New Britain, MD (US)

(72) Inventors: Kelsey L. Barkley, Pikesville, MD (US); David J. Thiess, Fallston, MD (US); Michael L. England, Towson, MD (US)

(21) Appl. No.: 19/539,303

(22) Filed: Feb. 13, 2026

Related U.S. Application Data
(63) Continuation of application No. PCT/US2024/042973, filed on Aug. 19, 2024.
(60) Provisional application No. 63/520,315, filed on Aug. 17, 2023.
(60) Provisional application No. 63/584,755, filed on Sep. 22, 2023.
(60) Provisional application No. 63/520,316, filed on Oct. 24, 2023.
(60) Provisional application No. 63/520,317, filed on Oct. 24, 2023.
(60) Provisional application No. 63/622,460, filed on Jan. 18, 2024.

(51) Int. Cl. H01M 50/24; H01M 50/247; H01M 50/262; H01M 50/296; H01M 50/298; H01M 50/588; H01R 9/24

(52) U.S. Cl. CPC H01M 50/24; H01M 50/247; H01M 50/262; H01M 50/296; H01M 50/298; H01M 50/588; H01M 2220/30; H01R 9/24

(57) ABSTRACT

An adaptor comprises a housing formed of a material having a first durometer, a first gasket and a second gasket. The housing includes a first portion, a second portion coupled to the first portion, and an internal cavity. The first portion and the second portion each includes an inner wall in the internal cavity and an outer wall in the internal cavity. A first pocket space is formed between the first portion outer wall and the first portion inner wall. Each of the first gasket and the second gasket is formed of a material having a second durometer. The second durometer is lower than the first durometer. The first gasket is insert molded in the first pocket space. A second pocket space is formed between the second portion outer wall and the second portion inner wall. The second gasket is insert molded in the second pocket space.

### CROSS-REFERENCE TO RELATED APPLICATION(S)

This application is a continuation of Patent Cooperation Treaty Application No. PCT/US2024/042973, filed on Aug. 19, 2024, entitled “Battery Pack Adaptor”, and claims the benefit of priority thereof under 35 U.S.C. § 120, and which claims the benefit of priority to each of: U.S. Provisional Patent Application Ser. No. 63/520,315, filed Aug. 17, 2023, titled “Battery Pack”; U.S. Provisional Patent Application Ser. No. 63/520,316 filed Aug. 17, 2023, titled “Battery Pack Charger”; U.S. Provisional Patent Application Ser. No. 63/520,317 filed Aug. 17, 2023, titled “Battery Pack Adaptor”; U.S. Provisional Patent Application Ser. No. 63/584,755 filed Sep. 22, 2023, titled “Battery Pack Interface”; and U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”.

### INCORPORATION BY REFERENCE

Patent Cooperation Treaty Application No. PCT/US2024/042973, filed on Aug. 19, 2024, entitled “Battery Pack Adaptor”, is incorporated herein in its entirety by reference.

U.S. Provisional Patent Application Ser. No. 63/520,315, filed Aug. 17, 2023, titled “Battery Pack”, is incorporated herein in its entirety by reference.

U.S. Provisional Patent Application Ser. No. 63/520,316, filed Aug. 17, 2023, titled “Battery Pack Charger”, is incorporated herein in its entirety by reference.

U.S. Provisional Patent Application Ser. No. 63/520,317, filed Aug. 17, 2023, titled “Battery Pack Adaptor”, is incorporated herein in its entirety by reference.

U.S. Provisional Patent Application Ser. No. 63/584,755 filed Sep. 22, 2023, titled “Battery Pack Interface”, is incorporated herein in its entirety by reference.

U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”, is incorporated herein in its entirety by reference.

This application is related to U.S. patent application Ser. No. 18/114,121, filed on Feb. 24, 2023, titled “Cordless Power Tool System”, which in turn claims the benefit of priority from U.S. Provisional Patent Application Ser. No. 63/268,451, filed on Feb. 24, 2022, titled “Cordless Power Tool System”, the contents all of which are incorporated herein in their entireties by reference.

This application also is related to Patent Cooperation Treaty Application No. PCT/US2024/042983, filed on Aug. 19, 2024, titled “Battery Packs, Battery Pack Chargers, Battery Pack Interfaces and Adaptors of a Cordless Power Tool System”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042984, filed on Aug. 19, 2024, titled “Battery Pack”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042979, filed on Aug. 19, 2024, entitled “Battery Pack Charger”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042976, filed on Aug. 19, 2024, titled “Battery Pack-Power Tool Interface”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042973, filed on Aug. 19, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042820, filed on Aug. 16, 2024, titled “Cordless Power Tool System”, which in turn claims the benefit of priority from U.S. Provisional Patent Application Ser. No. 63/622,475, filed Jan. 18, 2024, the contents all of which are incorporated herein in their entireties by reference.

### FIELD

The patent application relates to a battery pack adaptor of a cordless power tool system.

### BACKGROUND

Removable, rechargeable battery packs are becoming ubiquitous as more and more devices become cordless to take advantage of the advances in battery technology. Such battery packs are commonly part of cordless power tool systems and are designed and configured to operate with a variety of cordless power tools.

Conventional rechargeable battery packs may include Li-Ion battery cells. Due to the nature of the chemistry of these battery packs, the United States and many other countries and international bodies, including the United Nations, have implemented special rules directed to the shipping of Li-Ion batteries. If a battery or battery pack exceeds these rules/limits, there are additional fees and shipping costs for shipping the battery pack. As such, there is an interest in keeping the Watt-hour levels below the 100 Wh limits. Today, it is common for Li-Ion batteries to exceed these limits. As battery power and capacity increases it will become more common for batteries to exceed these limits. As such, there is a great desire to keep address this issue.

Typically, shipping regulations impose limitations upon how much energy is disposed in a battery pack. For example, some regulations require that each cell have an energy equal to or less than 20 Watt-hours, and that each battery pack has an energy limit equal to or less than 100 Watt-hours. It is preferable to provide a solution that can maximize the energy available to the end user while complying with shipping regulations. Preferably, a switching system could be used to separate components of the battery pack, thus opening the battery pack circuit, limiting the energy output.

While, for ground service (highway and rail), United States Department of Transportation (USDOT) regulations allow for certain packaging and shipment exceptions for batteries below 300 watt-hours, USDOT regulations for batteries above 300 watt-hours require special packaging (e.g., “Class 9” packaging) around the battery packs for shipment to be permissible.

The present patent application describes an example battery pack for use with a power tool system utilizing pouch battery cells and an example method of manufacturing such a battery pack.

Typically, rechargeable battery packs are charged using battery pack chargers that are designed and configured to charge specific battery packs. These chargers are designed and configured to plug into a wall outlet for access to alternating current (AC) mains line (utility) power or some other source of AC power, such as a generator. The battery packs, the power tools, and the chargers generally include an interface system that enables the battery pack to couple to the power tool and the charger, as is well known in the art. Various interfaces are known for electrically and physically coupling the battery pack with an electrical apparatus such as a power tool or a battery pack charge.

While prior art power tool systems including a set of cordless power tools, a set of releasably attachable battery packs and a set of battery pack chargers all designed and configured to operate with each other by an original equipment manufacturer have proven to be more than suitable for their intended purposes, each battery pack in the set of battery packs is limited for use with an associated tool of the set of cordless power tools and an associated charger of the set of battery pack chargers. Thus, it remains desirable in the art to provide an adaptor for a first battery pack having a first configuration specifically designed and configured to operate with a first type of power tool system that enables use of the first battery pack as a substitute for a second battery pack having a second configuration specifically designed and configured to operate with a second type of power tool system. Further, the cordless power tools and the battery packs may be used in heavy contamination environments. This type of environment may expose the cordless power tools and the battery packs to water and particulate ingress that may reduce the performance and warranty life expectancy. The present patent application provides improvements in the battery pack adaptors.

### SUMMARY

One aspect of the present patent application provides an adaptor. The adaptor comprises a housing, a first gasket and a second gasket. The housing is formed of a material having a first durometer. The housing includes a first portion, a second portion coupled to the first portion, and an internal cavity. The first portion of the housing includes an inner wall in the internal cavity and an outer wall in the internal cavity. A first pocket space is formed between the first portion outer wall and the first portion inner wall. The first gasket is formed of a material having a second durometer. The second durometer is lower than the first durometer. The first gasket is insert molded in the first pocket space. The second portion of the housing includes an inner wall in the internal cavity and an outer wall in the internal cavity. A second pocket space is formed between the second portion outer wall and the second portion inner wall. The second gasket is formed of the material having the second durometer. The second gasket is insert molded in the second pocket space.

Implementations of the foregoing aspects may include one or more of the following features.

In an aspect of the present patent application, the first portion and the second portion may form an opening to the internal cavity. The internal cavity is configured to receive a battery pack therein. The housing may include a third portion to cover the opening to the internal cavity. The third portion may include a rib configured to engage the first gasket and the second to seal the internal cavity of the adaptor.

In an aspect of the present patent application, the material having the second durometer may include a material selected from the group consisting thermoplastic elastomer material and a rubber material.

In an aspect of the present patent application, the material having the first durometer may include a material selected from the group consisting of a glass filled nylon material, a polycarbonate material, and an Acrylonitrile Butadiene Styrene material.

In an aspect of the present patent application, the material having the second durometer may include a soft durometer material.

In an aspect of the present patent application, the material having the first durometer may include a hard durometer material.

In an aspect of the present patent application, the third portion may be a door that is configured to be movably connected to one of the first and the second portions of the housing. The door may include an actuation lever with an over center latch that is configured to engage with a catch disposed on one of the first and the second portions of the housing so as to releasably connect the door to one of the first and the second portions of the housing.

In an aspect of the present patent application, the rib may include a gasket engaging portion having a cross-sectional configuration that is selected from the group consisting of a rectangular cross-sectional configuration, a square cross-sectional configuration, and a V-shaped cross-sectional configuration.

In an aspect of the present patent application, the first gasket may include a geometry that is selected from the group consisting of a rectangular cross-sectional geometry, a square cross-sectional geometry, a V-shaped cross-sectional geometry, and a U-shaped cross-sectional geometry.

In an aspect of the present patent application, the first gasket may include a first rib engaging surface.

In an aspect of the present patent application, the first gasket may include a first rounded rib engaging portion.

In an aspect of the present patent application, the second gasket may include a geometry that is selected from the group consisting of a rectangular geometry, a square geometry, a rounded geometry, a V-shaped cross-sectional geometry, and a U-shaped cross-sectional geometry.

In an aspect of the present patent application, the second gasket may include a second rib engaging surface.

In an aspect of the present patent application, the second gasket may include a second rounded rib engaging portion.

In an aspect of the present patent application, the adaptor may include an adaptor tool terminal block having a plurality of tool engaging terminals that are configured to engage with terminals of a power tool and an adaptor battery pack terminal block having a plurality of battery pack engaging terminals that are configured to engage with terminals of a battery pack. The adaptor tool terminal block may be disposed within the housing. The adaptor battery pack terminal block may be disposed in the internal cavity of the housing. The battery pack may be configured to be not directly attachable to the power tool either physically or electrically.

In an aspect of the present patent application, the third portion of the housing may include support members configured to enable the adaptor to stand on a surface.

In an aspect of the present patent application, the adaptor may include an adaptor tool terminal block having a plurality of tool engaging terminals that are configured to engage with terminals of a power tool, an adaptor battery pack terminal block having a plurality of battery pack engaging terminals that are configured to engage with terminals of a battery pack, and a wire harness having a plurality of power wires and a plurality of signal wires. The plurality of battery pack engaging terminals of the adaptor battery pack terminal block may include power terminals and signal terminals. The plurality of tool engaging terminals of the adaptor tool terminal block may include power terminals and signal terminals. Each power wire may include a first terminal end and a second terminal end. The first terminal ends of the power wires may be configured to be connected to the power terminals of the adaptor tool terminal block. The second terminal ends of the power wires may be configured to be connected to the power terminals of the adaptor battery pack terminal block. Each signal wire may include a first terminal end and a second terminal end, The second terminal ends of the signal wires may be configured to be connected to the signal terminals of the adaptor battery pack terminal block. The first terminal ends of the signal wires may be configured to be connected to a printed circuit board. The plurality of tool engaging terminals may include signal terminals that are connected to the printed circuit board.

In an aspect of the present patent application, the adaptor may further comprise a potting boat. A portion of the wire harness and the adaptor tool terminal block may be disposed in the potting boat.

In an aspect of the present patent application, the adaptor may further comprise a terminal holder configured to be positioned over the power terminals and the signal terminals of the adaptor tool terminal block.

In an aspect of the present patent application, the printed circuit board and portions of the wire harness may be encapsulated, either partially or entirely, by a potting material.

Another aspect of the present patent application provides a method of assembling a wiring assembly of an adaptor. The adaptor may include an adaptor tool terminal block having a plurality of tool engaging terminals that are configured to engage with terminals of a power tool, an adaptor battery pack terminal block having a plurality of battery pack engaging terminals that are configured to engage with terminals of a battery pack, a printed circuit board, a potting boat, a potting material, a terminal holder, and a wire harness having a plurality of power wires and a plurality of signal wires. Each power wire may include a first terminal end and a second terminal end. Each signal wire may include a first terminal end and a second terminal end. The plurality of battery pack engaging terminals of the adaptor battery pack terminal block may include power terminals and signal terminals. The plurality of tool engaging terminals of the adaptor tool terminal block may include power terminals and signal terminals. The method may comprise the steps of: connecting the first terminal ends of the power wires to the power terminals of the adaptor tool terminal block, connecting the second terminal ends of the power wires to the power terminals of the adaptor battery pack terminal block, connecting the first terminal ends of the signal wires to the printed circuit board, connecting the second terminal ends of the signal wires to the signal terminals of the adaptor battery pack terminal block, connecting the signal terminals of the plurality of tool engaging terminals to the printed circuit board, disposing the wire harness, the adaptor tool terminal block, and the adaptor battery pack terminal block in the potting boat, positioning the terminal holder over the power terminals and the signal terminals of the adaptor tool terminal block, and encapsulating the printed circuit board, either partially or entirely, by the potting material.

An aspect of the present patent application includes an electronic device, such as a battery pack adaptor, having a housing, the housing formed by a molding process, the housing including a pocket, the pocket including an inner wall and an outer wall opposed to the inner wall, a space formed between the pocket inner wall and the pocket outer wall, a seal/gasket formed, by a molding process, for example, injection molding in the space formed between the pocket inner wall and the pocket outer wall. The inner wall and the outer wall are composed of a high durometer material, for example, glass filled nylon (GFN) material, polycarbonate (PC) material, or Acrylonitrile Butadiene Styrene (ABS). The seal/gasket is composed of a low durometer material, for example, a thermoplastic elastomer (TPE) material.

The housing may include a first portion and a second portion, the second portion mated with first portion at a mating line (ML). A seal between the first portion and the second portion at the mating line. One of the first portion and the second portion including a rib along at least a portion of the mating line and the other of the first portion and the second portion including an injection molded gasket along the at least a portion of the mating line.

A wall of the first portion may extend towards the second portion in a first direction and terminating in a terminal end at or generally about the mating line. The terminal end may include a different geometries.

A second portion may include a seal assembly, an inner wall, and an outer wall, the inner wall, and the outer wall at least in part defining/forming a pocket/chamber/space. The inner wall and outer wall may be formed of a high durometer material. The seal may be formed by injection molding process. A gasket may be formed by an injection molding process of low durometer material in the pocket/chamber/space of the seal assembly.

Advantages may include one or more of the following. An innermold seal with a soft durometer seal may allow for the elimination or reduction of water and particulate ingress while being a permanent feature of the electronic device. This may reduce part complexity while upholding the need for a seal for contamination ingress. These and other advantages and features will be apparent from the description and the drawings.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIGS. 1 and 2 show an example power tool system in accordance with an embodiment of the present patent application;

FIG. 3 shows a rear end elevation view of a battery pack adaptor in accordance with an embodiment of the present patent application;

FIG. 4 shows a left side elevation view of the battery pack adaptor;

FIG. 5 shows a front end elevation view of the battery pack adaptor;

FIG. 6 shows a right side elevation view of the battery pack adaptor;

FIG. 7 shows a top plan view of the battery pack adaptor;

FIG. 8 shows a bottom plan view of the battery pack adaptor;

FIGS. 9-16 show various isometric views of the battery pack adaptor;

FIGS. 17-18 show a front end view and an isometric view, respectively, of the battery pack adaptor;

FIG. 19 shows an exploded isometric view of the battery pack adaptor, wherein the door of the battery pack adaptor is in the open position and before the battery pack is inserted into the internal cavity of the housing;

FIG. 20 shows an isometric view of the battery pack adaptor, wherein the door of the battery pack adaptor is in the open position and after the battery pack is inserted into and received in the internal cavity of the housing;

FIG. 21 shows an isometric view of the battery pack adaptor, wherein the battery pack is received in the internal cavity of the housing and the door of the battery pack adaptor is in one of intermediate positions, the one or more intermediate positions are between the open position and a closed position, wherein the illustrated intermediate position is closer to the closed position than the open position;

FIGS. 22-24 show isometric views of the battery pack adaptor, wherein the door is in the closed position and the over center latch of the door being coupled to the catch of the housing to retain the door in the closed position, wherein FIG. 24 also shows chamfers to push out the latch with a power tool terminal block;

FIGS. 25-26 show side/bottom and isometric views, respectively, of the battery pack adaptor;

FIG. 27A shows an example housing of the battery pack adaptor;

FIGS. 27B-27E show cross-sectional views of several example embodiments of an insert molded seal/gasket insert;

FIG. 28 shows an isometric view of a first housing portion of the battery pack adaptor and an example seal/gasket;

FIG. 29 shows an isometric view of the first housing portion of the battery pack adaptor with the first gasket insert molded into the first housing portion;

FIG. 30 shows an isometric view of a second housing portion of the battery pack adaptor and an example seal/gasket;

FIG. 31 shows an isometric view of the second housing portion of the battery pack adaptor with the outer wall removed;

FIG. 32 shows an isometric view of the second housing portion of the battery pack adaptor with the second gasket insert molded into the second housing portion;

FIG. 33 shows an isometric view of the battery pack adaptor, wherein the door is in the closed position and the over center latch on the door being coupled to the catch on the housing to retain the door in the closed position;

FIG. 34 shows an isometric view of the battery pack adaptor, wherein the door is in the open position;

FIGS. 35A and 35B show cross-sectional views of the battery pack adaptor, taken along line A-A in FIG. 4, wherein FIG. 35A shows the pocket space without the gasket and FIG. 35B shows with the gasket insert molded into the housing;

FIG. 35C shows an isometric view of the battery pack adaptor, taken along line A-A in FIG. 4, with the gasket insert molded into the housing;

FIGS. 36A and 36B show cross-sectional views of the battery pack adaptor, taken along line B-B in FIG. 4, wherein FIG. 36A shows the pocket space without the gasket and FIG. 36B shows with the gasket insert molded into the housing;

FIGS. 37A and 37B show cross-sectional views of the battery pack adaptor, taken along line C-C in FIG. 4, wherein FIG. 37A shows the pocket space without the gasket and FIG. 37B shows with the gasket insert molded into the housing;

FIG. 37C shows an isometric view of the battery pack adaptor, taken along line C-C in FIG. 4, with the gasket insert molded into the housing;

FIG. 38 shows a cross-sectional view of the battery pack adaptor, taken along line D-D in FIG. 4;

FIG. 39 shows an isometric view of the housing of the battery pack adaptor, wherein the door is not shown to better illustrate the other components of the adaptor;

FIG. 40 shows a top view of the housing of the battery pack adaptor, wherein the door is not shown to better illustrate the other components of the adaptor and the gasket insert molded in the housing is shown;

FIGS. 41A and 41B show cross-sectional views of the battery pack adaptor, taken along line E-E in FIG. 4, wherein FIG. 41A shows the pocket space without the gasket and FIG. 41B shows with the gasket insert molded into the housing;

FIG. 41C shows an isometric view of the battery pack adaptor, taken along line E-E in FIG. 4, with the gasket insert molded into the housing;

FIGS. 42A and 42B show cross-sectional views of the battery pack adaptor, taken along line F-F in FIG. 7 wherein FIG. 42A shows the pocket space without the gasket and FIG. 42B shows with the gasket insert molded into the housing;

FIG. 42C shows an isometric view of the battery pack adaptor, taken along line F-F in FIG. 7, with the gasket insert molded into the housing;

FIGS. 43A and 43B show isometric and top views, respectively, of a wire harness assembly of the battery pack adaptor at a first step of assembly;

FIGS. 44A and 44B show isometric and top views, respectively, of the wire harness assembly of the battery pack adaptor at a second step of assembly;

FIG. 45 shows an isometric view of the wire harness assembly of the battery pack adaptor at a third step of assembly;

FIGS. 46A and 46B show isometric and top views, respectively, of the wire harness of the battery pack adaptor at a fourth step of assembly;

FIGS. 47A and 47B show isometric and top views, respectively, of the wire harness of the battery pack adaptor at a fifth step of assembly; and

FIGS. 48A and 48B show isometric and top views, respectively, of the wire harness of the battery pack adaptor at a sixth step of assembly.

### DETAILED DESCRIPTION

Additional details of embodiments of various battery packs and power tools considered within the scope of the present disclosure can be found in at least U.S. Provisional Patent Application Nos. 62/636,395, 62/853,694, 62/636,568, 63/359,940, 63/533,751, 63/533,754, 63/533,755, 63/533,758, 63/578,008; U.S. patent application Ser. No. 18/114,121; U.S. Pat. No. 9,406,915; European Patent Application Nos. EP22202110.7, EP22194105.7, EP23163288.6, and EP23192793.0; PCT Patent Application Nos. PCT/EP2022/074710, PCT/EP2023/072939,PCT/EP2023/072638, and PCT/EP2023/072679; and U.K. Patent Application Nos. GB2112789.9, GB2209009.6, and GB2218350.3. The disclosures of each of the above applications and patents are hereby incorporated by reference in their entirety.

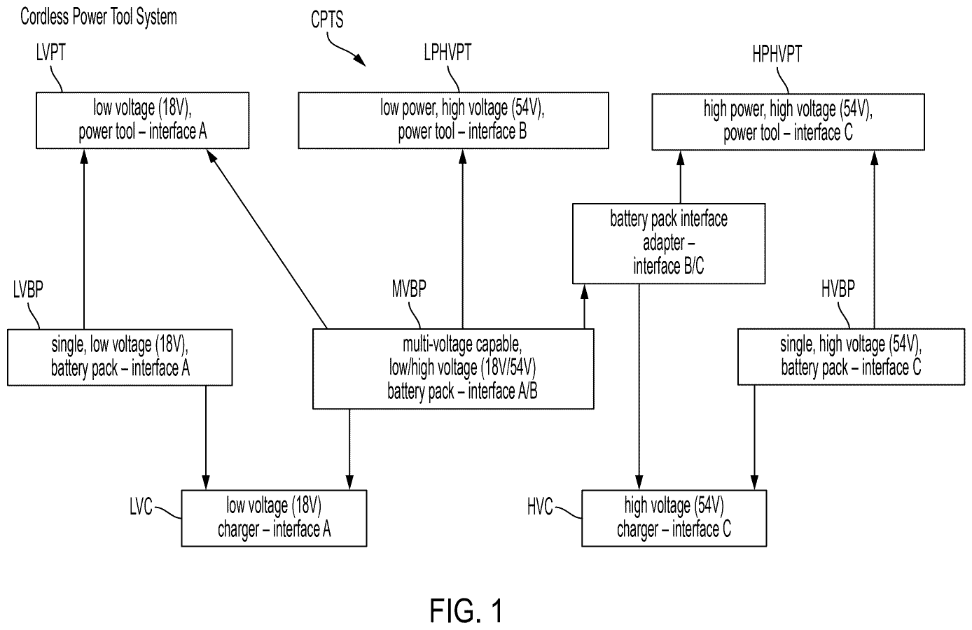

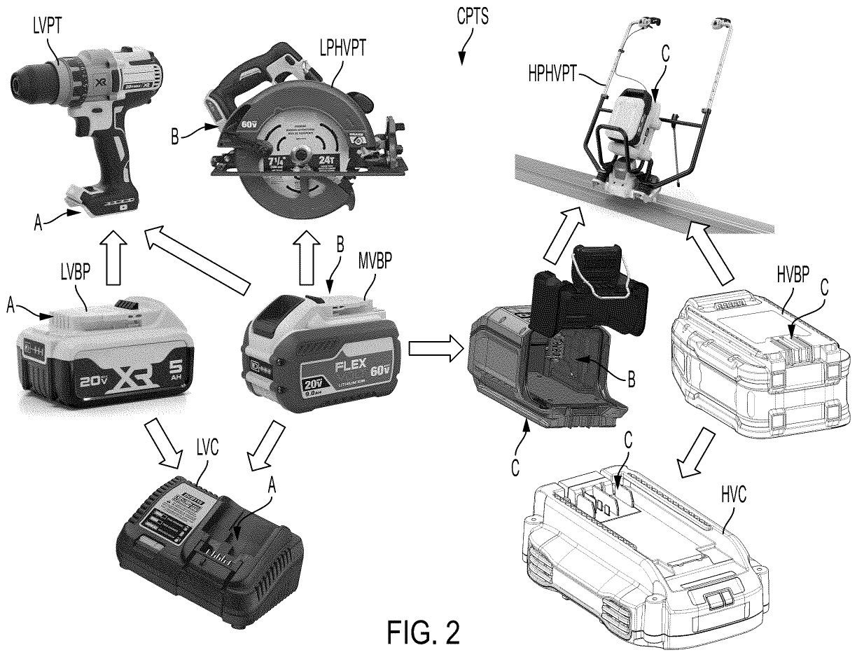

Referring to FIGS. 1-2, the present patent application provides a cordless power tool system (CPTS). The CPTS may include a first power tool, a second power tool, a third power tool, a first battery pack, and a second battery pack 3100. The first power tool may include a high power, high voltage power tool (HPHVPT). The HPHVPT may have a first power tool rated voltage (e.g., 54 volts (V)). The HPHVPT may have a first power tool interface (e.g., interface C). The second power tool may include a low power, high voltage power tool (LPHVPT). The LPHVPT may have a second power tool rated voltage (e.g., 54V). The LPHVPT may have a second power tool interface (e.g., interface B) that is different from the first power tool interface (e.g., interface C). The third power tool may include a low voltage power tool (LVPT). The LVPT may have a third power tool rated voltage (e.g., 18V). The LVPT may have a third power tool interface (e.g., interface A) that is different from the first power tool interface (e.g., the interface C) and the second power tool interface (e.g., the interface B).

Referring to FIGS. 1-2, in one example embodiment, the CPTS may include the HVBP 100 and a set of cordless HPHVPT (one shown). The CPTS also may include the HVC. Each of the cordless power tools of the set of cordless power tools may be powered by the HVBP. The set of power tools may include, for example, a screed, a concrete plate compactor, a rammer, a concrete vibrator powerpack, a concrete vibrator backpack, and a concrete/core drill. It is understood that the HPHVPT illustrated in FIGS. 1-2 are examples and that other power devices are contemplated to be included as part of the CPTS, even though not illustrated. In one example implementation, the HPHVPT have an operating voltage of 54V. Each HPHVPT may include a receptacle for receiving the HVBP. The power tool receptacle includes an interface for mating with the HVBP. The battery pack receptacle is configured with one interface for receiving one removable, rechargeable battery pack from the HVBP.

The first battery pack may be a single (fixed), high voltage battery pack (HVBP). The HVBP may have a first nominal voltage (e.g., 54V) that is substantially the same as the first power tool rated voltage (e.g., 54V). The HVBP may have the first battery pack interface (e.g., the interface C) that is connectable to the first power tool interface (i.e., the interface C) to provide power to the HPHVPT. The first battery pack interface (e.g., the interface C) of the HVBP is not connectable to the second power tool interface (e.g., the interface B) or the third power tool interface (e.g., the interface A).

The second battery pack 3100 may be a multi-voltage capable (low voltage/high voltage battery pack (MVBP) 3100. The MVBP 3100 may have a second battery pack interface (e.g., the interface A/B) that is coupleable to the second power tool interface (e.g., the interface B) of the LPHVPT and that is coupleable to the third power tool interface (i.e., the interface A) of the LVPT.

The MVBP 3100 may have the first nominal voltage (e.g., 54V) that is substantially the same as the first power tool rated voltage (e.g., 54V) when the MVBP is coupled to the HPHVPT or connected to the LPHVPT and may have a second nominal voltage (e.g., 18V) that is substantially the same as the third power tool rated voltage (e.g., 18V) when the MVBP 3100 is connected to the LVPT. The MVBP 3100 may be configured to be coupled to the HPHVPT to provide power to the HPHVPT (e.g., it will require the adaptor to couple the MVBP 3100 and the HPHVPT). It is noted that, in the present patent application, the battery and the power tool may be “connected” when there is no adaptor, while the battery and the power tool may be “coupled” when there is an adaptor. The MVBP 3100 may also be configured to be connected to the LVPT to provide power to the LVPT.

The CPTS may further comprise an adaptor 3000 having a first adaptor interface (e.g., interface C) configured to be connected to the first power tool interface (e.g., the interface C) of the HPHVPT and a second adaptor interface (e.g., interface B) configured to be connected to the second battery pack interface (e.g., the interface A/B) of the MVBP to couple the MVBP to the HPHVPT.

The second battery pack interface (e.g., the interface A/B) of the MVBP is not able to be coupled to the first power tool interface (e.g., the interface C) of the HPHVPT without the adaptor 3000.

The rated voltage of the HPHVPT and the rated voltage of the LPHVPT are the same. The rated voltage of the HPHVPT and the rated voltage of the LPHVPT may be 54V.

The nominal voltage of the HVBP and the nominal voltage of the MVBP may be the same. The nominal voltage of the HVBP and the nominal voltage of the MVBP may be 54V.

The third battery pack may be a single (fixed) voltage (low voltage) battery pack (LVBP). The LVBP may have the second nominal voltage (e.g., 18V) that is substantially the same as the third power tool rated voltage (e.g., 18V). The LVBP may have a third battery pack interface (e.g., the interface A) that is connectable to the third power tool interface (e.g., the interface A) of the third power tool HPHVPT. The third battery pack LVBP may have a third battery pack interface (e.g., the interface A) that is not connectable to the first power tool interface (e.g., the interface C) of the HPHVPT or the second power tool interface (e.g., the interface B) of the LPHVPT.

As used in this application, rated voltage may refer to the advertised voltage, or the operating voltage, depending on the context. The rated voltage may also encompass a single (fixed) voltage, several discrete voltages, or one or more ranges of voltages. As used in the application, rated voltage may refer to any of these types of voltages or a range of any of these types of voltages.

Advertised Voltage: With respect to power tools, battery packs, and chargers, the advertised voltage generally refers to a voltage that is designated on labels, packaging, user manuals, instructions, advertising, marketing, or other supporting documents for these products by a manufacturer or seller so that a user is informed which power tools, battery packs, and chargers will operate with one another. The advertised voltage may include a numeric voltage value, or another word, phrase, alphanumeric character combination, icon, or logo that indicates to the user which power tools, battery packs, and chargers will work with one another. In some embodiments, as discussed below, a power tool, battery pack, or charger may have a single advertised voltage (e.g., 20V or 60V), a range of advertised voltages (e.g., 20V-60V), or a plurality of discrete advertised voltages (e.g., 20V/60V). As discussed further below, a power tool may also be advertised or labeled with a designation that indicates that it will operate with both a DC power supply and an AC power supply (e.g., AC/DC or AC/60V). An AC power supply may also be said to have an advertised voltage, which is the voltage that is generally known in common parlance to be the AC mains voltage in a given country (e.g., 120 VAC in the United States and 220 VAC-240 VAC in Europe).

Operating Voltage: For a power tool, the operating voltage generally refers to a voltage or a range of voltages of AC and/or DC power supply(ies) with which the power tool, its motor, and its electronic components are designed to operate. For example, a power tool advertised as a 120V AC/DC tool may have an operating voltage range of 92V-132V. The power tool operating voltage may also refer to the aggregate of the operating voltages of a plurality of power supplies that are coupled to the power tool (e.g., a 120V power tool may be operable using two 60V battery packs connected in series). For a battery pack and a charger, the operating voltage refers to the DC voltage or range of DC voltages at which the battery pack or charger is designed to operate. For example, a battery pack or charger advertised as a 60V battery pack or charger may have an operating voltage range of 51V-60V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS operating voltage of 120V and an average positive operating voltage of 108V.

Nominal Voltage: For a battery pack, the nominal voltage generally refers to the average DC voltage output from the battery pack. For example, a battery pack advertised as a 60V battery pack, with an operating voltage of 51V-60V, may have a nominal voltage of 54V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS nominal voltage of 120V and an average positive nominal voltage of 108V.

Maximum Voltage: For a battery pack, the maximum voltage may refer to the fully charged voltage of the battery pack. For example, a battery pack advertised as a 60V battery pack may have a maximum fully charged voltage of 60V. For a charger, the maximum voltage may refer to the maximum voltage to which a battery pack can be recharged by the charger. For example, a 60V charger may have a maximum charging voltage of 60V.

It should also be noted that certain components of the power tools, battery packs, and chargers may themselves be said to have a voltage rating, each of which may refer to one or more of the advertised voltage, the operating voltage, the nominal voltage, or the maximum voltage. The rated voltages for each of these components may encompass a single voltage, several discrete voltages, or one or more ranges of voltages. These voltage ratings may be the same as or different from the rated voltage of power tools, battery packs and chargers. For example, a power tool motor may be said to have its own an operating voltage or range of voltages at which the motor is designed to operate. The motor rated voltage may be the same as or different from the operating voltage or voltage range of the power tool. For example, a power tool having a voltage rating of 60V-120V may have a motor that has an operating voltage of 60V-120V or a motor that has an operating voltage of 90V-100V.

The power tools, power supplies, and chargers also may have ratings for features other than voltage. For example, the power tools may have ratings for motor performance, such as an output power (e.g., maximum watts out (MWO) as described in U.S. Pat. No. 7,497,275, which is incorporated by reference herein in its entirety—“the '275 Patent”) or motor speed under a given load condition. In another example, the battery packs may have a rated capacity, which refers to the total energy stored in a battery pack. The battery pack rated capacity may depend on the rated capacity of the individual cells and the manner in which the cells are electrically connected.

This application also refers to the ratings for voltage (and other features) using relative terms such as low, medium, high, and very high. The terms low rated, medium rated, high rated, and very high rated are relative terms used to indicate relative relationships between the various ratings of the power tools, battery packs, AC power supplies, chargers, and components thereof, and are not intended to be limited to any particular numerical values or ranges. For example, it should be understood that a low rated voltage is generally lower than a medium rated voltage, which is generally lower than a high rated voltage, which is generally lower than a very high rated voltage.

Each of the power tools—LVPT, LPHVPT or HPHVPT—may include a housing. Each power tool housing may incorporate components/elements such as a motor and a working element of the power tool. Each of the power tools LVPT, LPHVPT or HPHVPT may also include a motor control circuit and a battery pack interface that are configured to enable operation from one or more DC battery pack power supplies that together have a rated voltage that corresponds to the rated voltage of the power tool. The motor may be any brushed or brushless DC electric motor, including, but not limited to, a permanent magnet brushless DC motor (BLDC), a permanent magnet DC brushed motor (PMDC), an induction motor, a universal motor, etc. The motor control circuit may include a power unit having one or more power switches (not shown) disposed between the power supply and the motor. The power switch may be an electro-mechanical on/off switch, a power semiconductor device (e.g., diode, FET, BJT, IGBT, etc.), or a combination thereof. The motor control circuit may further include a control unit or controller. The control unit may be arranged to control a switching operation of the power switches in the power unit. The motor control circuit may control the motor in fixed or variable speed. The control unit may include a micro-controller or similar programmable module configured to control gates of power switches. Additionally or alternatively, the control unit may be configured to monitor and manage the operation of the DC battery pack power supplies. Additionally or alternatively, the control unit may be configured to monitor and manage various tool operations and conditions.

The LVPT may include, but is not limited to, at least one of the following power tools: a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger. The LVPT may be configured to operate at a rated voltage of 18 V.

The LVPT may be configured to be powered by a single LVBP, which may be charged using an LVC that is designed and configured to charge the LVBP. The LVPT, the LVBP, and the LVC may have the same interface (e.g., the interface A). The interfaces may be configured for electrically and physically coupling the LVBP with the LVPT and/or the LVC.

The LPHVPT may be configured to operate at a rated voltage of 54 V. The power tool interface of the LPHVPT may be referred to as interface B in this patent application. The LPHVPT may include, but is not limited to, at least one of the following power tools: a circular saw, a drill, a grinder, a miter saw, a reciprocating saw, a rotary hammer, or a table saw.

The LPHVPT may be configured to be powered by a MVBP, which may be charged using a LVC. The LVC may be designed and configured to charge either the LVBP or the MVBP. The MVBP may be configured to power either the LVPT or the LPHVPT. The MVBP is also described in detail in U.S. Pat. No. 9,406,915, which is incorporated herein in its entirety.

The MVBP interface may incorporate two interfaces (e.g., the interface A and the interface B). The LPHVPT and the MVBP may both include the same interface (e.g., the interface B). The LVPT and the MVBP may both include the same interface (e.g., the interface A). The iinterface A may be configured for electrically and physically coupling the MVBP with the LVPT and/or LVC and the interface B may be configured for electrically and physically coupling the MVBP with the LPHVPT using the adaptor 3000.

The HPHVPT may be configured to operate at a rated voltage of 54V or higher. The power tool interface of the HPHVPT may be referred to as the interface C in this patent application. The HPHVPT may include, but is not limited to, at least one of the following power tools: a jack hammer a concrete drill, a concrete saw, a 12 inch cut-off saw, a concrete vibrator, a plate/concrete plate compactor, a rammer, or a screed/concrete screed. Such HPHV power tools are also described in detail in U.S. Patent Application Publication No. 2023-0291049, which is incorporated herein in its entirety. These power tools may require a relatively high amount of power and/or runtime compared to the LPHVPT. The HPHVPT may also include, but is not limited to, a concrete mixer, a jobsite lift, a block saw, a concrete finisher, an early entry saw, and a jobsite buggy, they may be referred to as very high power tools. These power tools may have the relatively high operating voltage. These power tools may require a relatively high amount of power and/or runtime compared to the LPHVPT.

The HPHVPT may be configured to be powered by a HVBP, which may be charged using a HVC that is designed and configured to charge the HVBP. The HPHVPT, the HVBP, and the HVC may have the same interface (e.g., the interface C). The interfaces may be configured for electrically and physically connecting the HVBP with the HPHVPT and/or the HVC.

However, it will be understood by those skilled in the art that the teachings of the present patent application are not so limited.

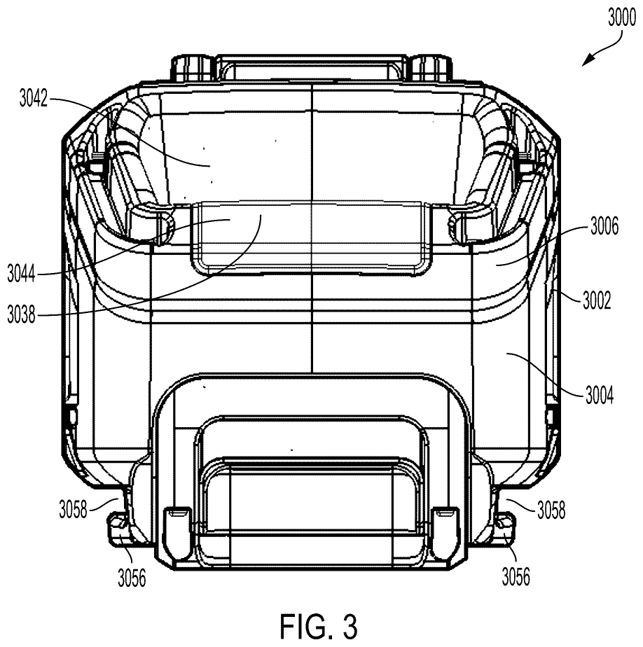

FIG. 3 shows a rear end view of a battery pack adaptor 3000 in accordance with an embodiment of the present patent application. The battery pack adaptor 3000 may be interchangeably referred to as an adaptor or an electronic device.

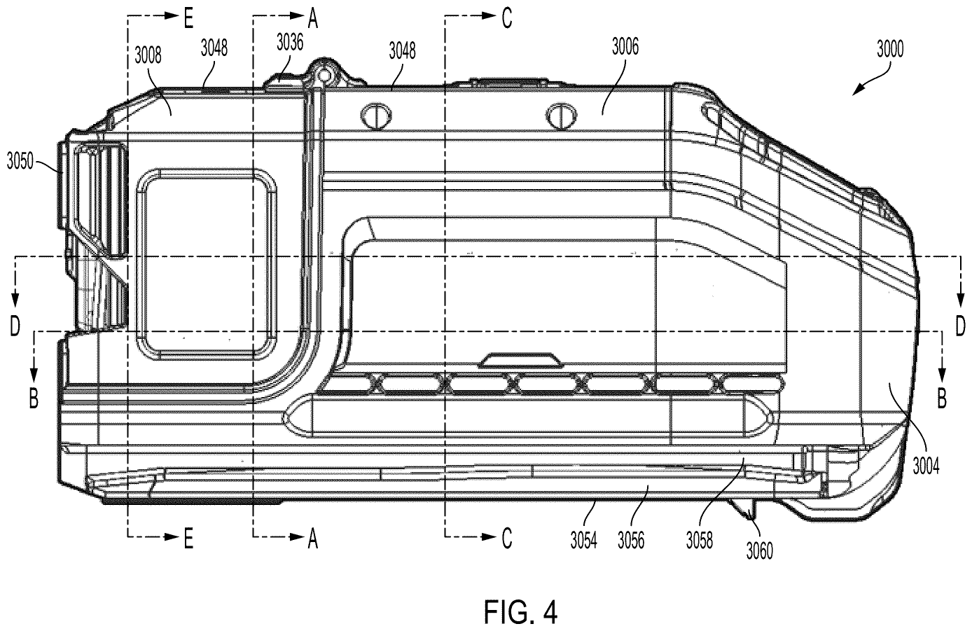

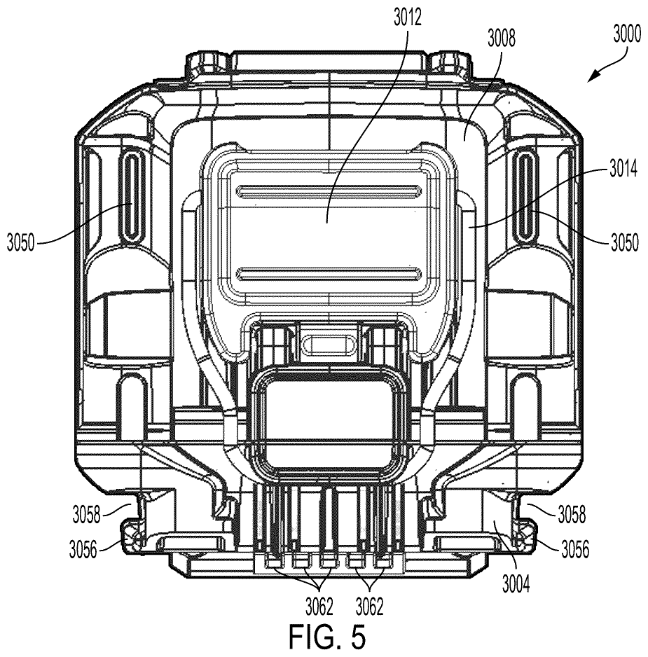

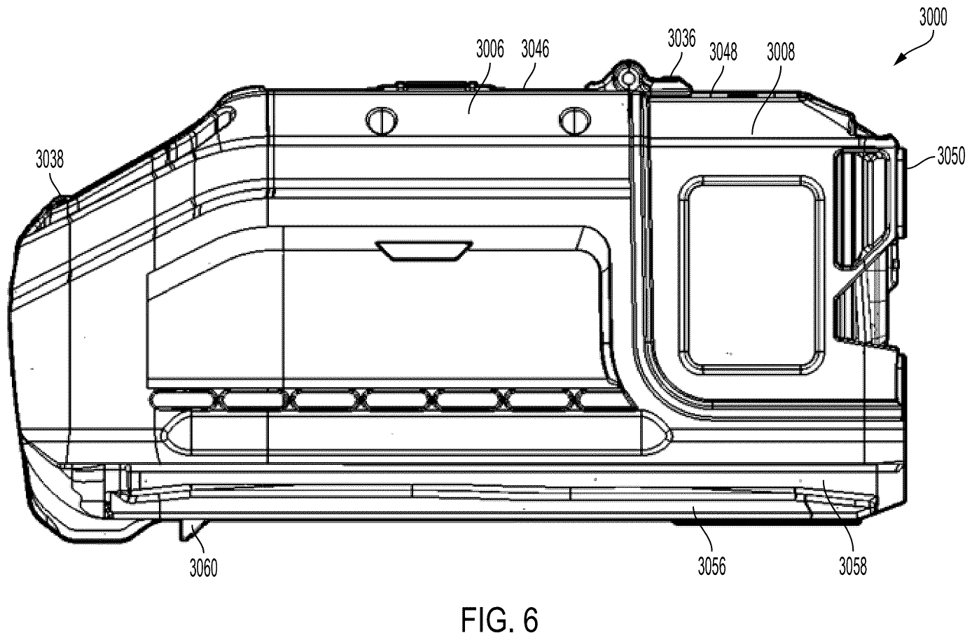

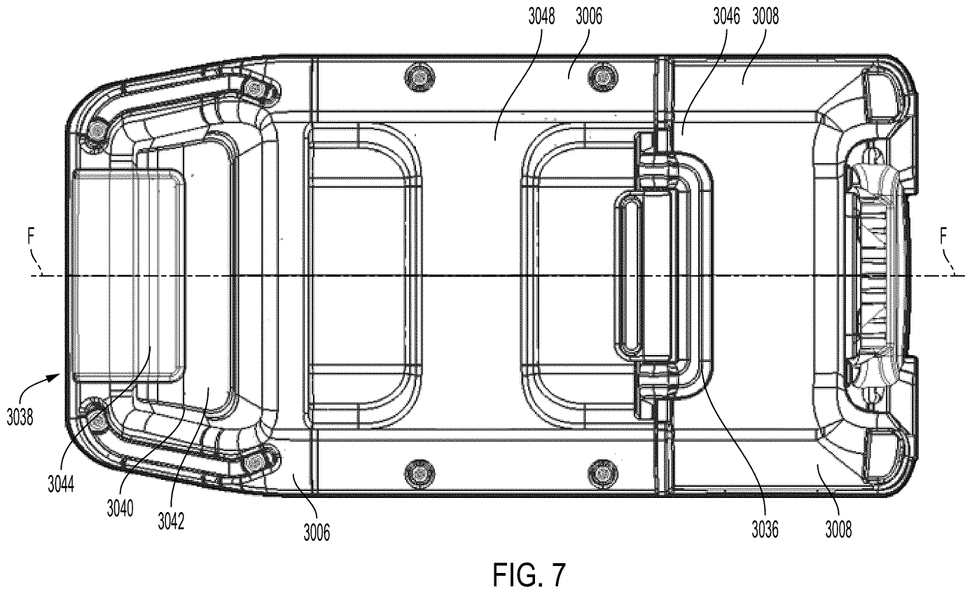

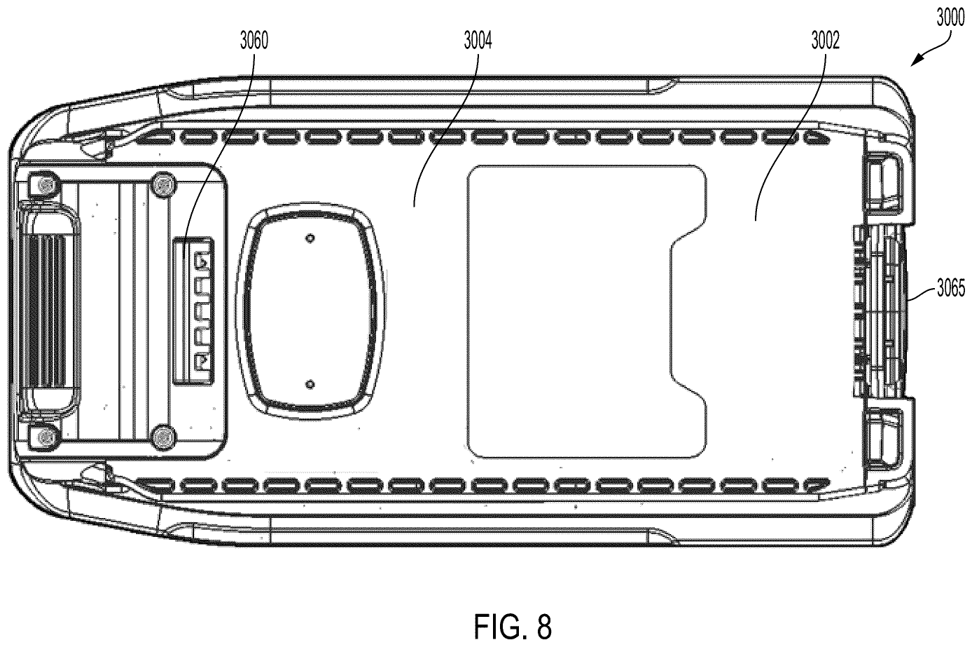

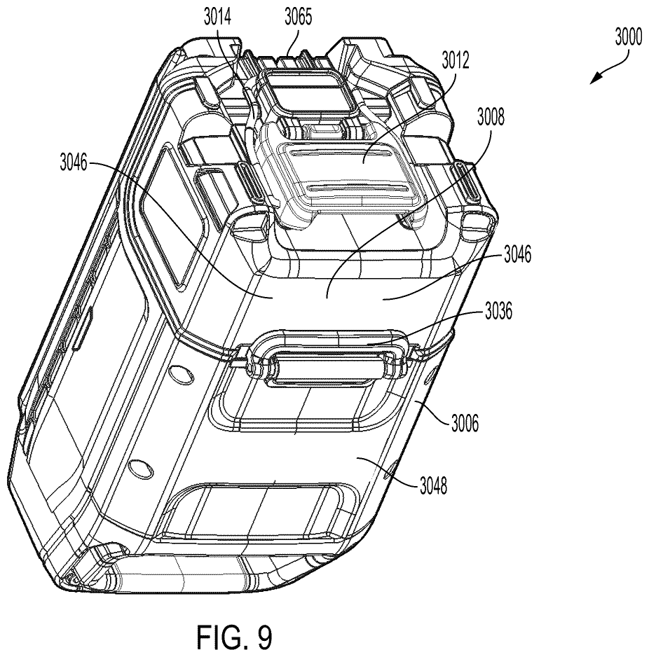

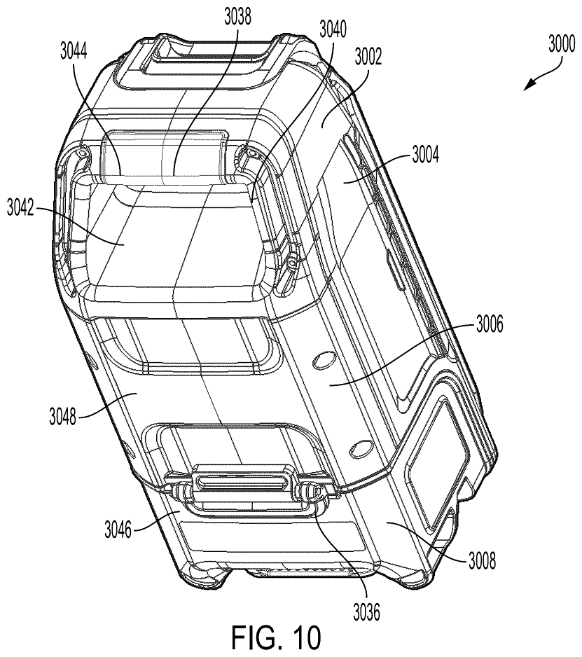

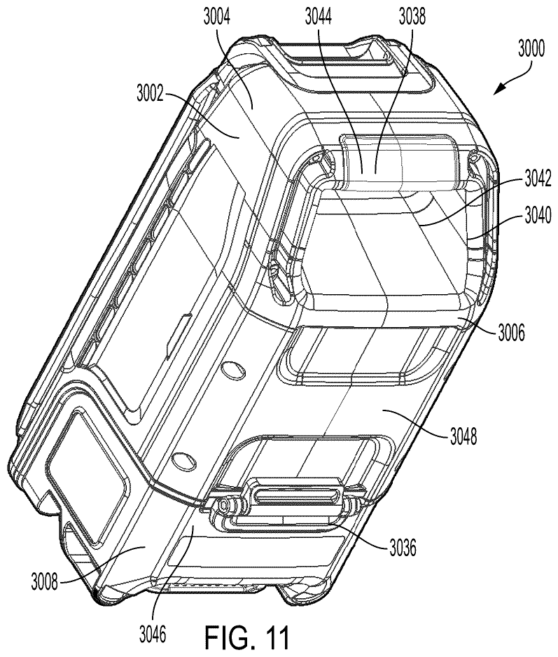

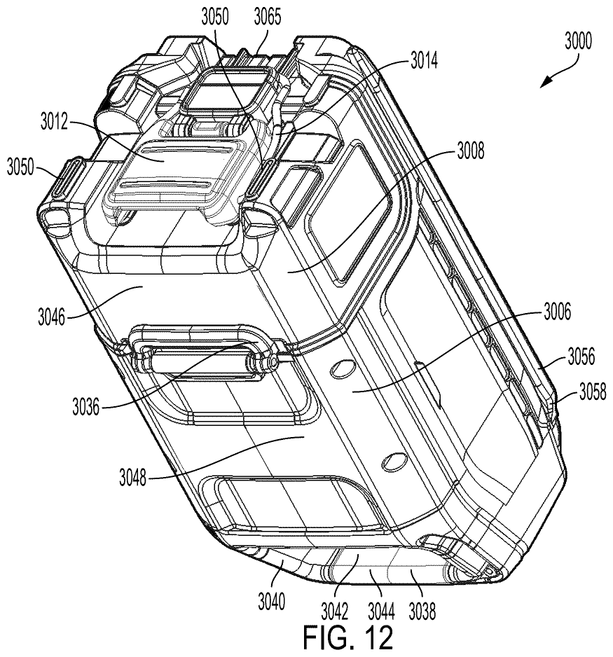

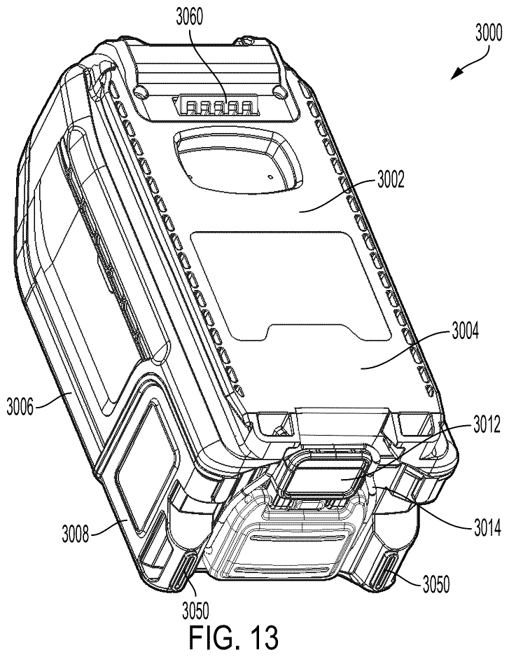

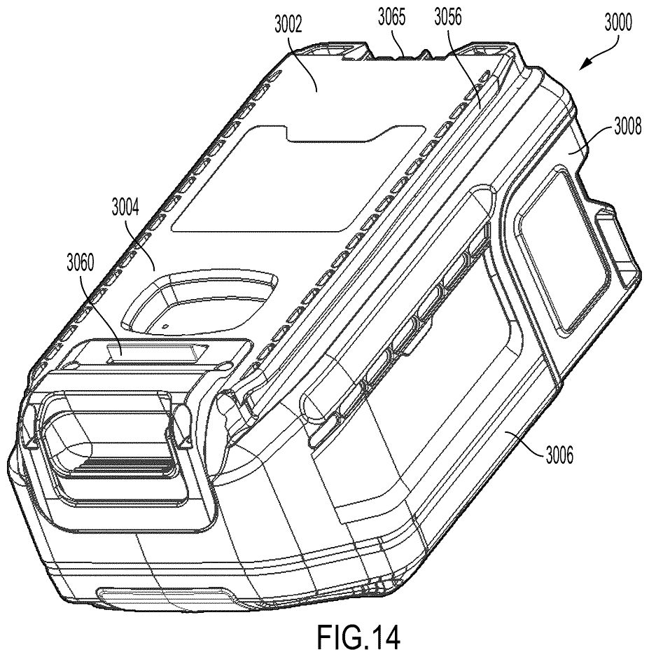

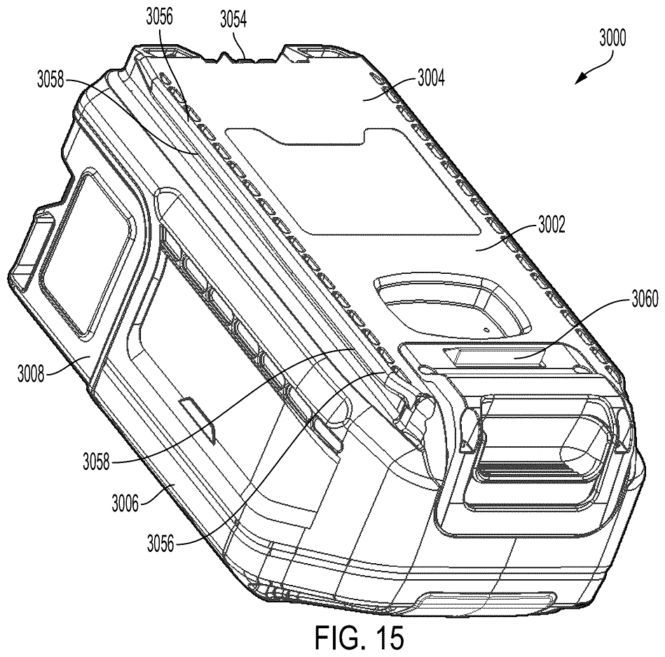

FIGS. 4, 5, 6, 7, and 8 show a left side view, a front end view, a right side view, a top elevational view, and a bottom elevational view, respectively, of the adaptor 3000. FIGS. 9-16 show perspective views of the of the adaptor 3000.

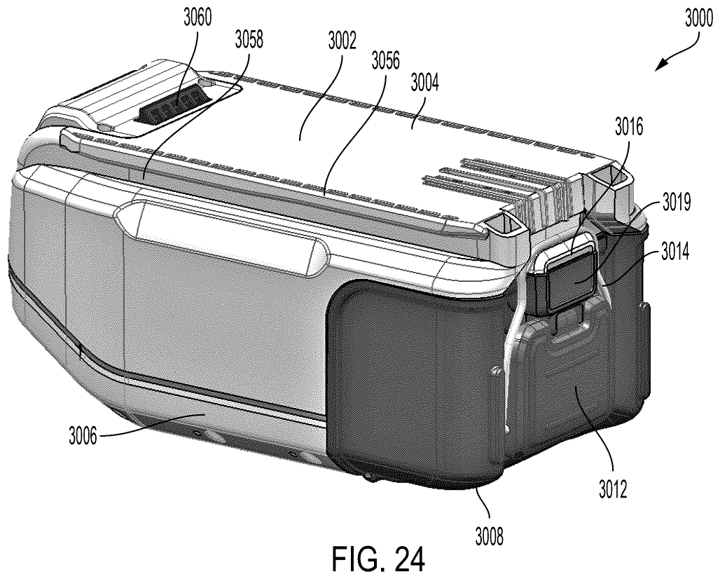

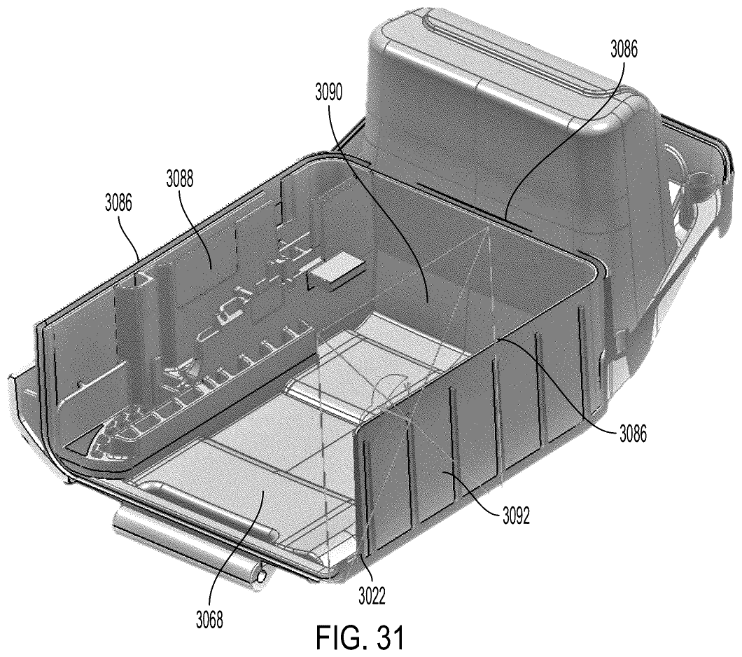

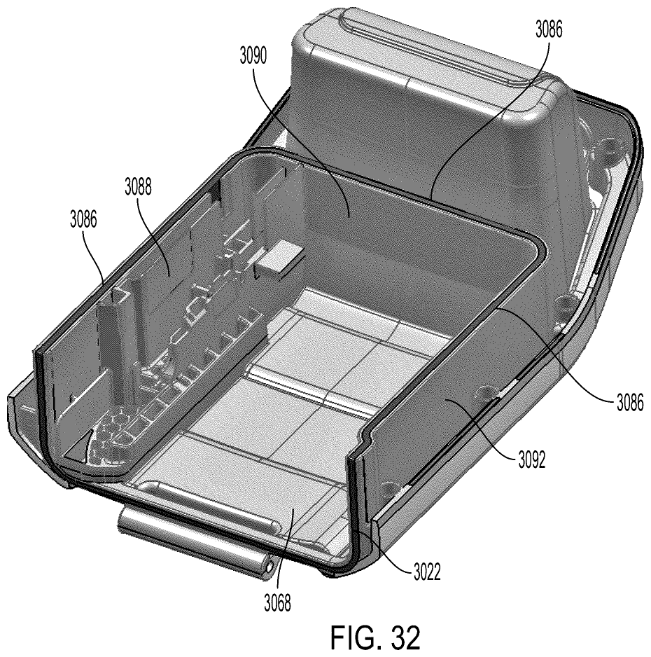

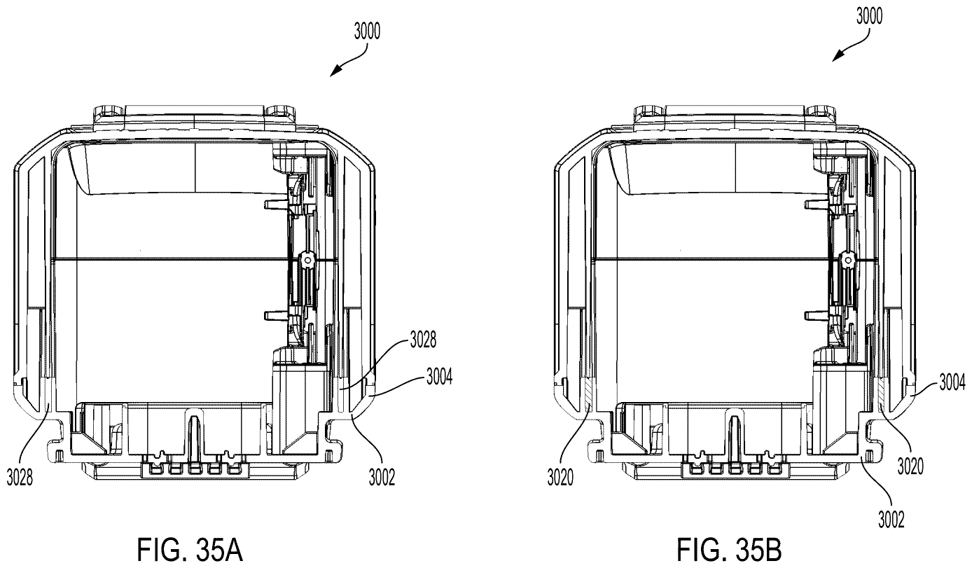

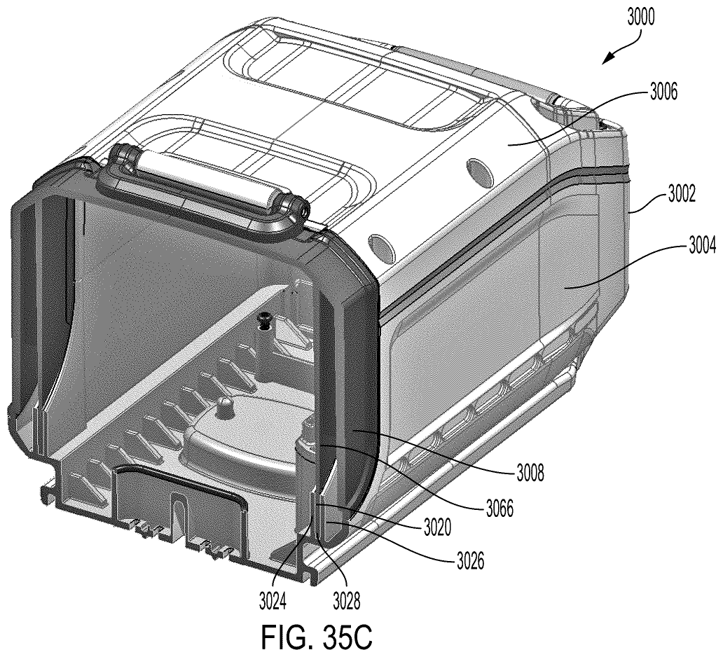

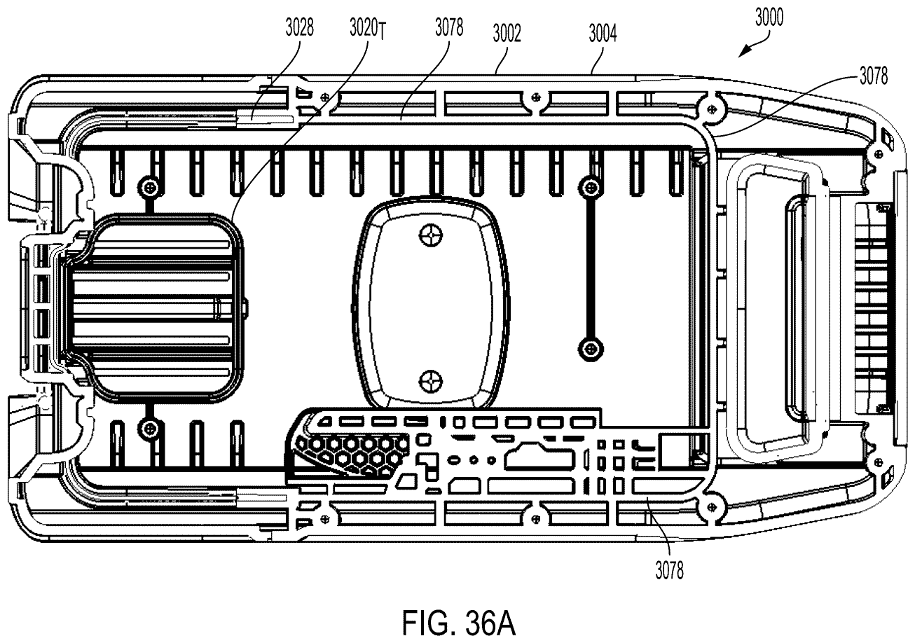

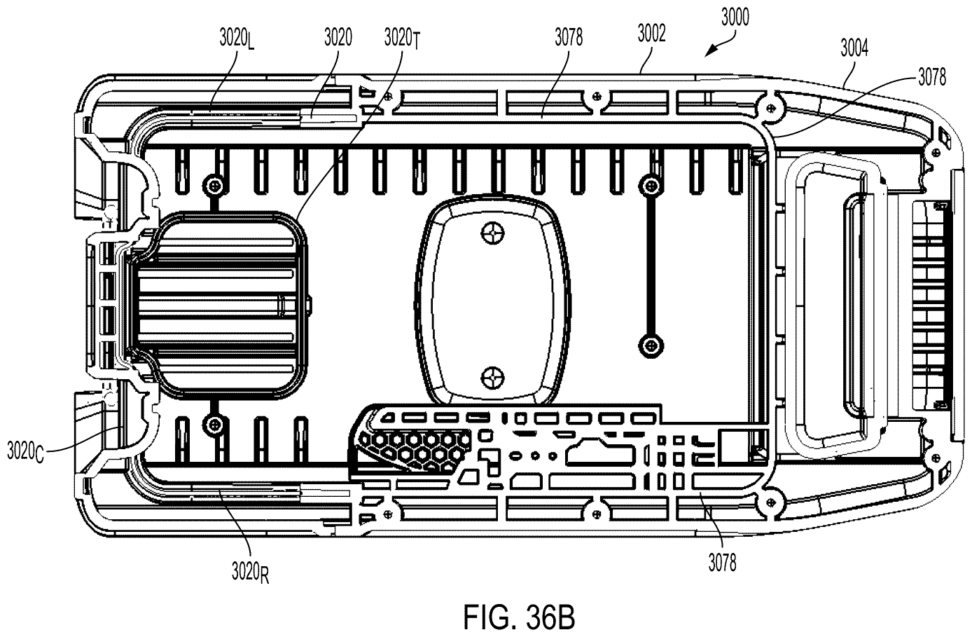

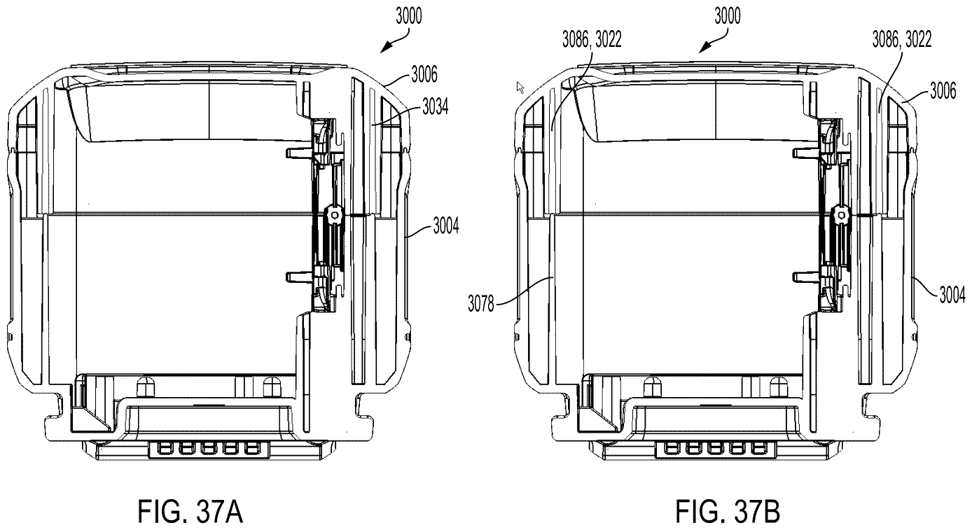

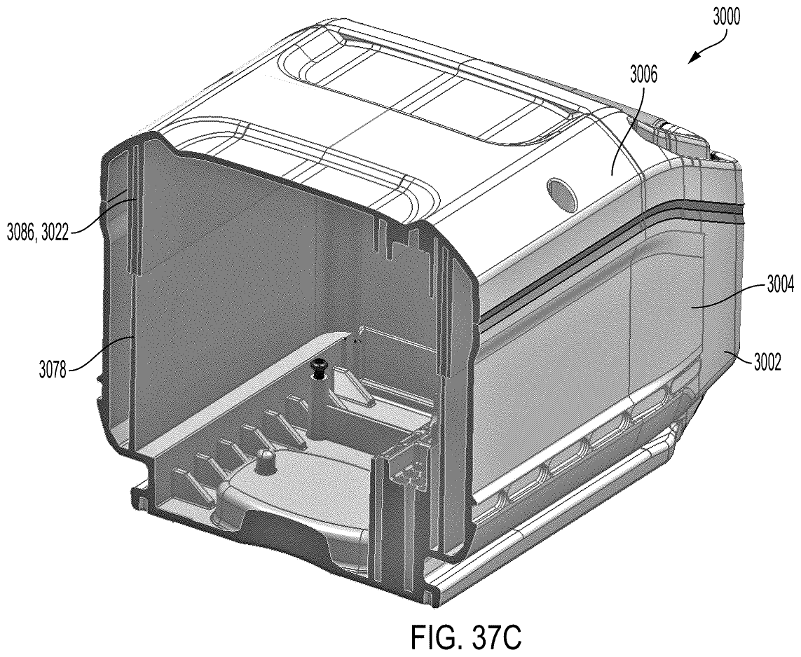

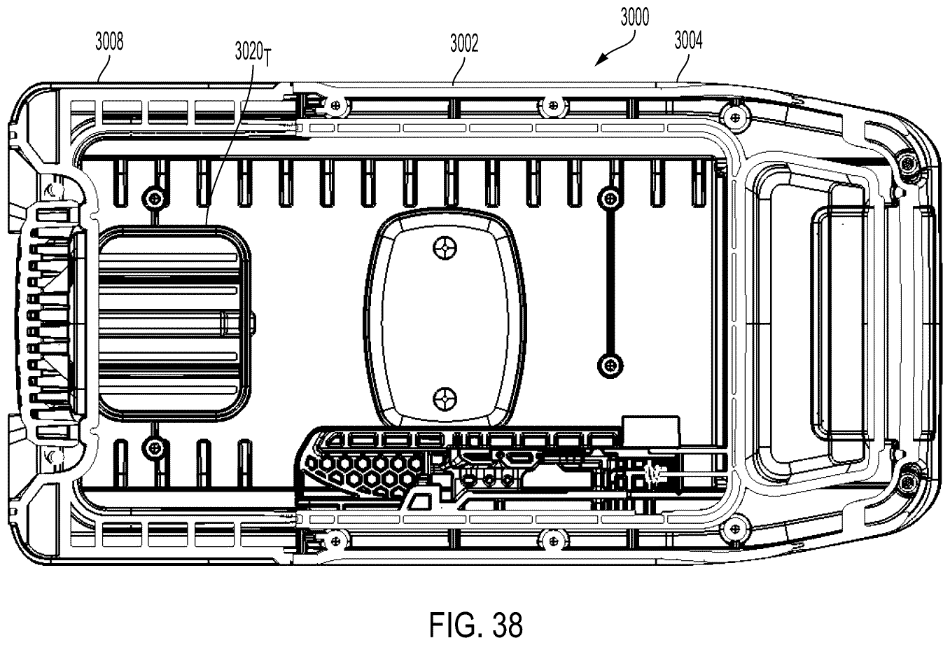

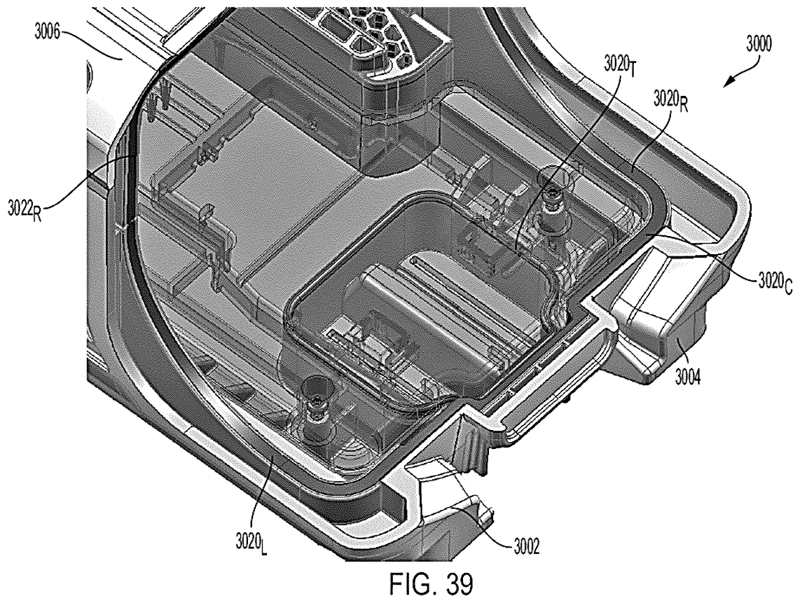

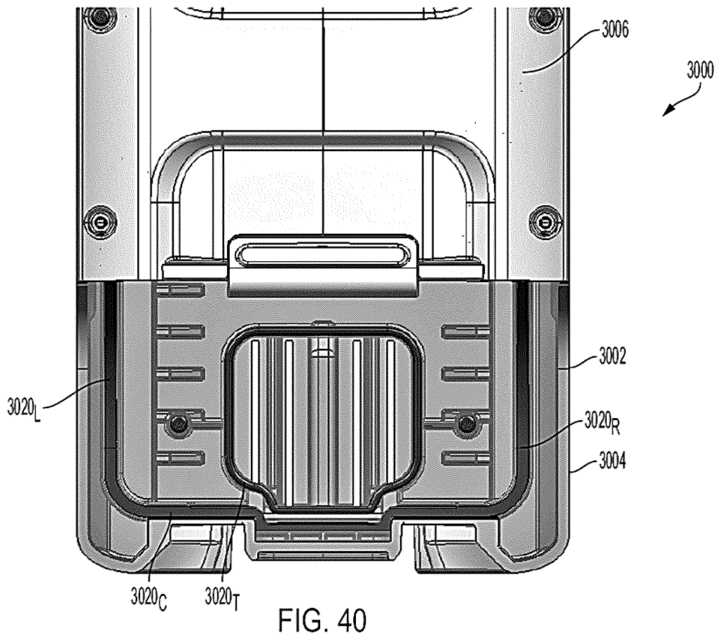

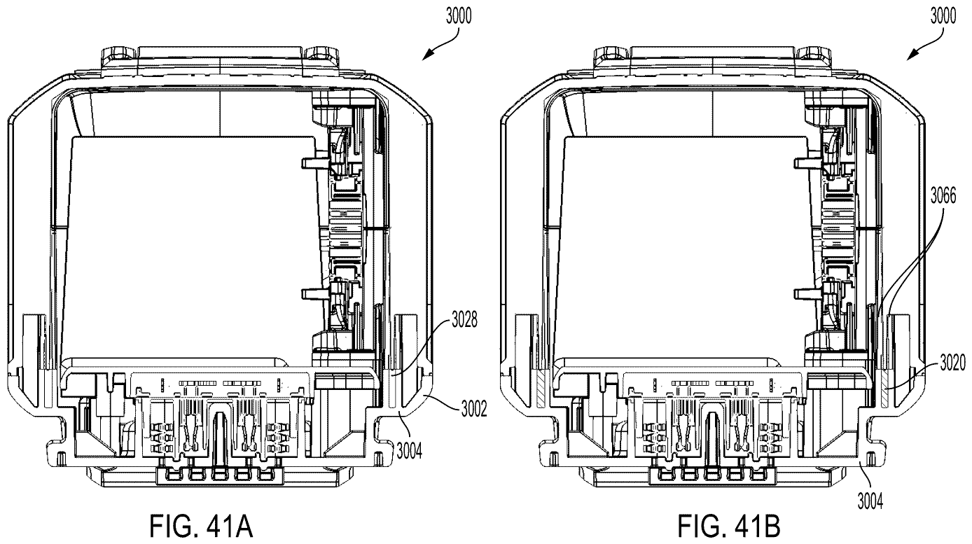

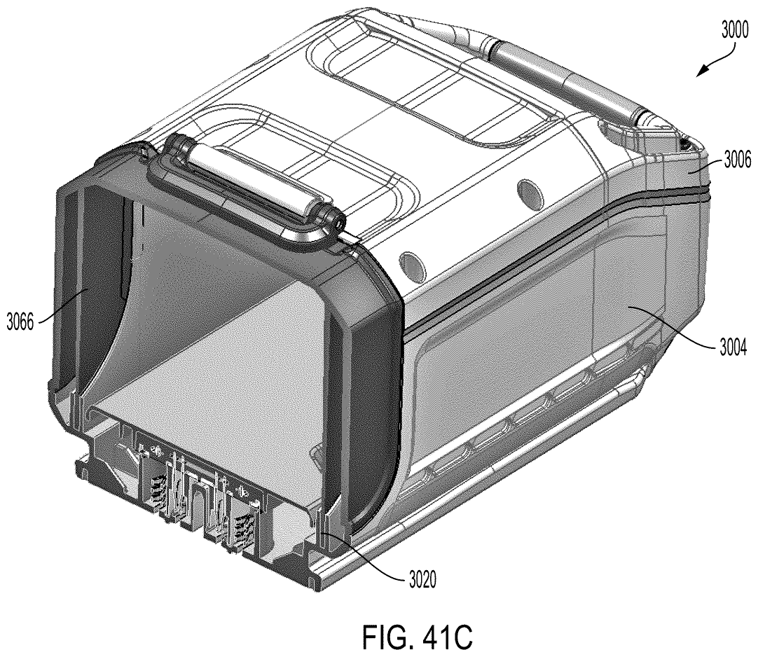

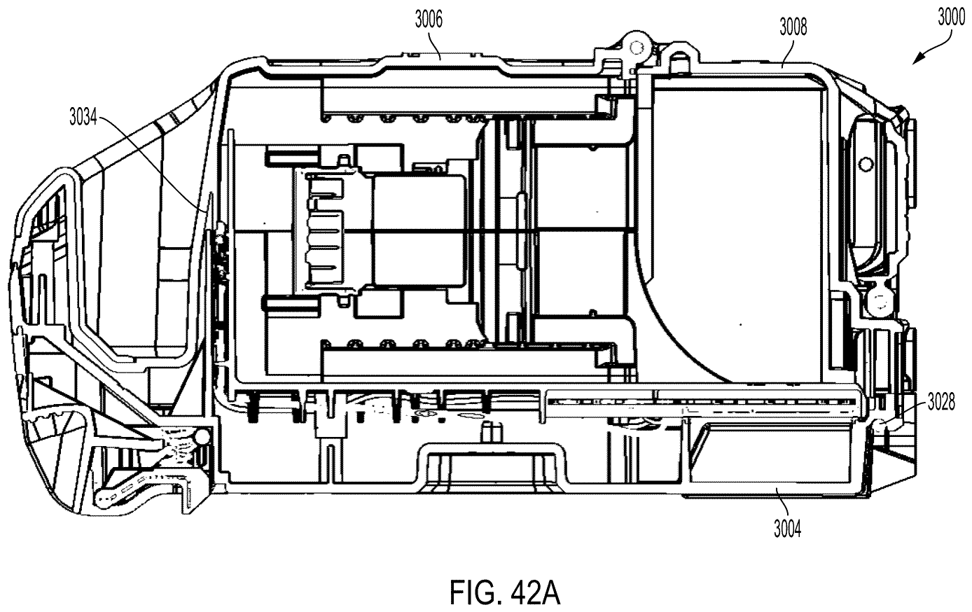

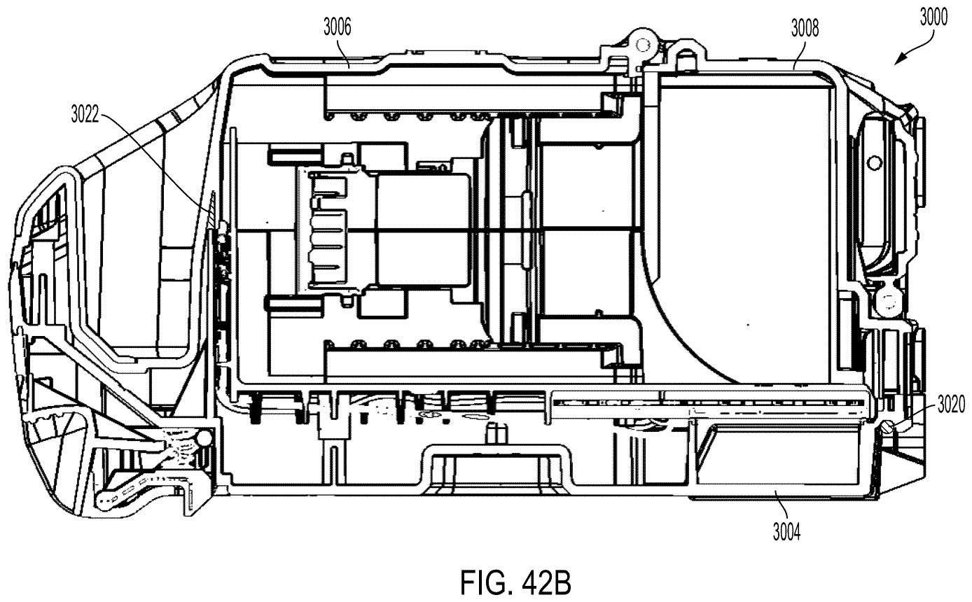

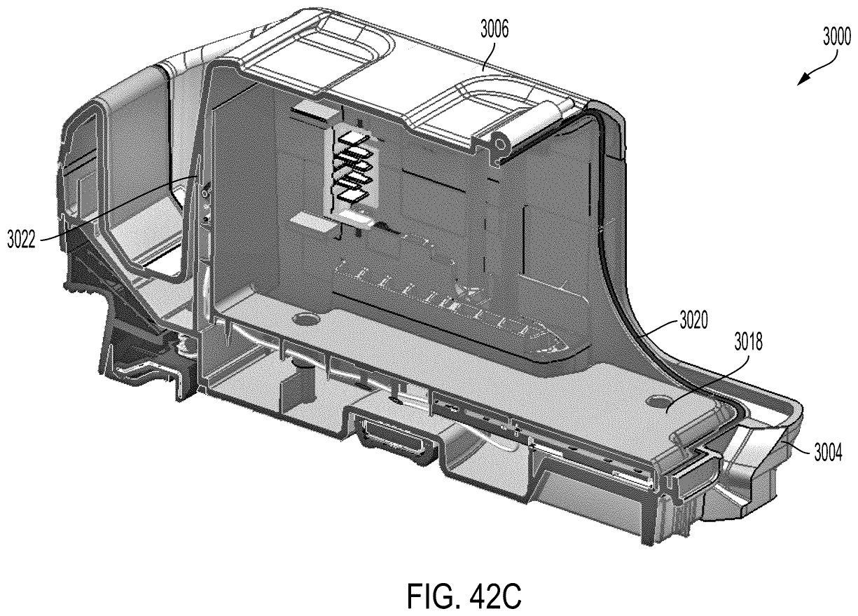

In one embodiment of the present patent application, referring to FIGS. 24-42C, the adaptor 3000 may include a housing 3002, a first gasket 3020, and a second gasket 3022. The housing 3002 may include a first portion 3004 and a second portion 3006 coupled to the first portion 3004. The housing 3002 may be formed of a material having a first durometer. The housing 3002 may also include an internal cavity 3010. The first portion 3004 of the housing 3002 may include an inner wall 3024 in the internal cavity 3010 and an outer wall 3026 in the internal cavity 3010. A first pocket space 3028 may be formed between the first portion outer wall 3026 and the first portion inner wall 3024. The first gasket 3020 may be formed of a material having a second durometer. The second durometer is lower than the first durometer. The first gasket 3020 may be insert molded in the first pocket space 3028. The second portion 3006 of the housing 3002 includes an inner wall 3030 in the internal cavity 3010 and an outer wall 3032 in the internal cavity 3010. A second pocket space 3034 is formed between the second portion outer wall 3032 and the second portion inner wall 3030. The second gasket 3022 may be formed of the material having the second durometer. The second gasket 3022 may be insert molded in the second pocket space 3034.

The adaptor 3000 may be configured to electrically interconnect a battery pack 3100 with an electrical apparatus, such as a power tool of a power tool system. That is, the adaptor 3000 may be configured to operatively couple the battery pack 3100 and the power tool. The battery pack 3100 may be the multi-voltage capable (low/high voltage) battery pack MVBP, which has been described in detail in the discussions in the present patent application. The power tool may be the high-power, high-voltage power tool (HPHVPT), which has been described in detail in the discussions in the present patent application.

The adaptor 3000 may be operatively associated with the battery pack 3100 and (the housing of) the power tool to complete an electrical circuit between the battery pack and the motor (of the power tool) that is carried by the power tool housing. The battery pack 3100 may be a non-dedicated battery pack 3100 but has a voltage compatible with the HPHVPT. As used herein, the term “non-dedicated” shall mean any battery pack that was not particularly designed for use with a specific tool housing and therefore is not directly attachable to the power tool/power tool housing either physically or electrically. That is, the battery pack may be designed for use with a specific tool housing just not the tool housing that requires the adaptor. The power tool system/assembly may include a battery pack from a first power tool system and a power tool housing from a second power tool system. For example, the second power tool system may include the HPHVPT, the HVBP, and a high-voltage battery charger (HVC). The first power tool system may include the low-voltage power tool (LVPT), the LPHVPT, the LVBP, the MVBP, and/or the LVC. The adaptor 3000 may be configured to enable the MVBP of the first power tool system to output electrical energy. The adaptor 3000 may be configured to electrically interconnect the MVBP of the first power tool system with (the motor of) the HPHVPT of the second power tool system. The MVBP of the first power tool system may be a MVBP having a nominal voltage of 54V, as described in detail in the discussions above.

The battery pack 3100, the adaptor 3000 and the HPHVPT may all mechanically and electrically couple together. In this manner, the battery pack 3100 may be used to provide power to the HPHVPT through the use of the adaptor 3000. This may also allow an existing power tool to receive power from the battery pack 3100 without any modification to the existing power tool to enable the existing power tool to connect to the battery pack 3100 as long as the battery pack, the power tool and the adaptor all have a common interface. The adaptor 3000 may be, thus, used to allow the battery pack to provide power to the power tool without modification to either the battery pack or the power tool.

The adaptor 3000 may generally be configured to be used with battery packs having different configurations. The adaptor 3000 may be configured to enable a first battery pack or a second battery pack to connect to the power tool. For example, the first battery pack may have a first configuration. The first configuration may include a first physical configuration and/or a first electrical configuration. The second battery pack may have a second configuration. The second configuration may include a second physical configuration and/or a second electrical configuration. The second configuration may be different from the first configuration.

For example, the HPHVPT may be configured to use a single (or a first) HVBP as a power source. However, the adaptor 3000 may also serve to electrically connect a different (or a second) high-voltage battery pack (e.g., MVBP) to the housing of the HPHVPT so that the HPHVPT is supplied with the same or substantially the same voltage as the first HVBP. The adaptor 3000 may be configured to allow for backward compatibility. A user may use old/legacy battery packs (with the same or substantially the same voltage, for example, the MVBP) with the HPHVPT. The first HVBP may have a nominal voltage of 54 volts and the second MVBP may have a nominal voltage of 54 volts. A battery pack having the nominal voltage of 54 volts may also be referred to as a high-voltage battery pack. The first and second HVBPs and the MVBP may have different physical volumes. The first and second HVBPs and the MVBP may have the same battery cell configuration. The first and second HVBPs and the MVBP may have different battery cell configurations. The battery cell configurations may generally include pouch cell configuration, tabless cell configuration, or cylindrical cell configuration, etc. The first and second high-voltage battery packs may have different battery interfaces.

The low-voltage battery pack may comprise (at least) a predetermined number of cells connected in series. The high-voltage battery pack may comprise (at least) triple the predetermined number of cells connected in series.

The low-voltage battery pack may incorporate, for example, double the predetermined number of cells, rather than the predetermined number of cells. In this case, the double the predetermined number of cells may comprise the predetermined number of pairs of cells connected in parallel, and the predetermined number of pairs of parallel-connected cells are connected in series to output a voltage of 18 volts. Likewise, the high-voltage battery pack may incorporate, for example, six times the predetermined number of cells, rather than triple the predetermined number of cells. In this case, the six times the predetermined number of cells comprise triple the predetermined number of pairs of cells connected in parallel and triple the predetermined number of pairs of parallel-connected cells are connected in series to output a voltage of 54 volts. As will be understood, however, the terms low-voltage and high-voltage are relative terms and are merely meant to indicate two battery packs, which normally supply currents at different voltages.

The adaptor 3000 may include the housing 3002. The housing 3002 of the adaptor 3000 may include the first housing portion 3004, the second housing portion 3006, and a door 3008. The door 3008 may be interchangeably referred to as the third portion or third housing portion of the housing. The first and second housing portions may be interchangeably referred to as the first and second portions of the housing. One of the first housing portion 3004 or the second housing portion 3006 may form the base/bottom of the adaptor 3000. The other of the first housing portion 3004 or the second housing portion 3006 may form the top of the adaptor 3000. The battery pack 3100 may be enclosed in the adaptor 3000 (including the first housing portion 3004, the second housing portion 3006, and the door 3008). The first and second housing portions 3004, 3006 may together form the internal cavity 3010 in the adaptor 3000. The first portion 3004 and the second portion 3006 may form an opening to the internal cavity 3010. The door 3008 may be configured to cover the opening to the internal cavity 3010. The internal cavity 3010 may be configured to receive the battery pack 3100 therein. The battery pack 3100 may be received in the internal cavity 3010 of the adaptor 3000. The adaptor 3000 may be sized and configured to receive the battery pack 3100 having a nominal voltage of 54 volts in the internal cavity 3010 in the adaptor 3000.

The first, second and third housing portions 3004, 3006, 3008 may be formed from a plastic material or other material. The first, second and third housing portions 3004, 3006, 3008 may be formed from a hard plastic material. The first, second and third housing portions 3004, 3006, 3008 of the housing 3002 is formed of a material having a first durometer. The first, second and third housing portions 3004, 3006, 3008 may be formed by molding procedure. The first, second and third housing portions 3004, 3006, 3008 may be formed by injection molding procedure.

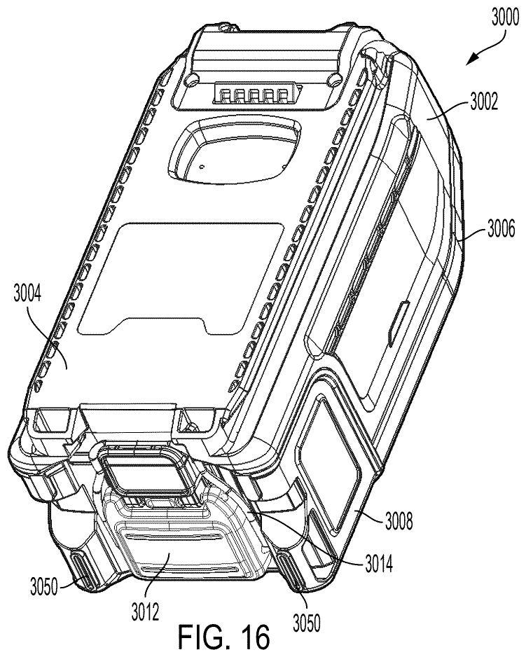

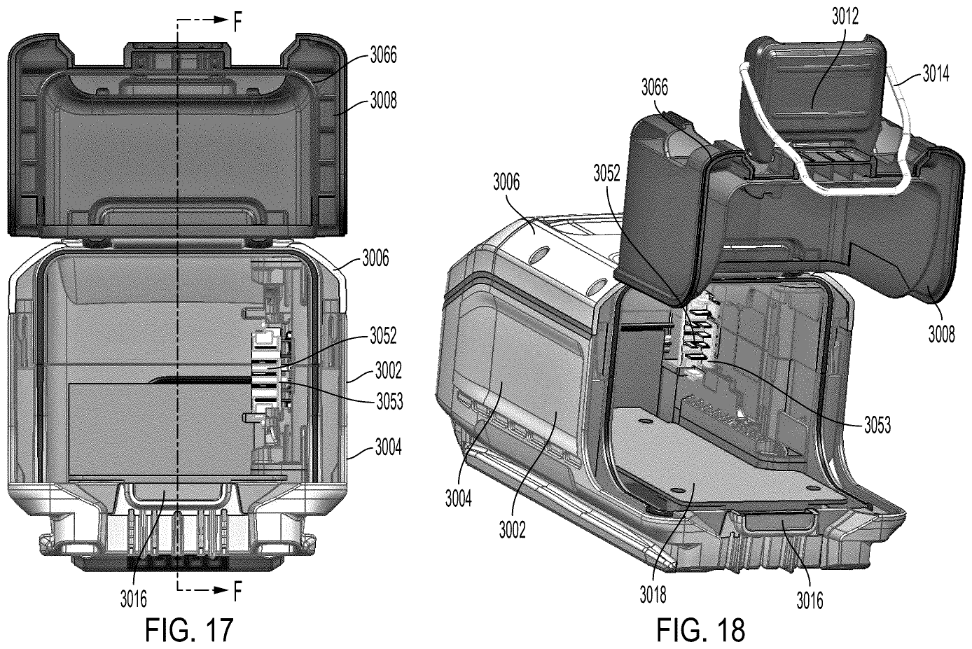

FIGS. 17-18 show the door 3008 of the battery pack adaptor 3000 in an open position, and the internal cavity 3010 in the housing 3002 ready to receive a battery pack (not shown here). FIG. 18 also shows an actuation lever 3012, an over center latch 3014, and a catch 3016. The catch 3016 may be disposed on portions of the housing 3002 and may be configured to engage with the over center latch 3014 disposed on the door 3008.

Referring to FIGS. 17-24, the third housing portion/door 3008 may be an access door, a movable door or a pivotable door. The door 3008 may be pivotally mounted for movement about a generally horizontal pivot axis between the open position in which the door 3008 allows access to the internal cavity 3010 of the adaptor 3000 and the closed position in which the door 3008 closes access to the internal cavity 3010 of the adaptor 3000. The door 3008 may be movably or hingedly attached/connected (e.g., via a pivot pin) to one of the first housing portion 3004 and the second housing portion 3006. In the illustrated embodiment, the door 3008 may be operatively connected to the second housing portion 3006. The door 3008 may be releasably connected/locked to the first housing portion 3004.

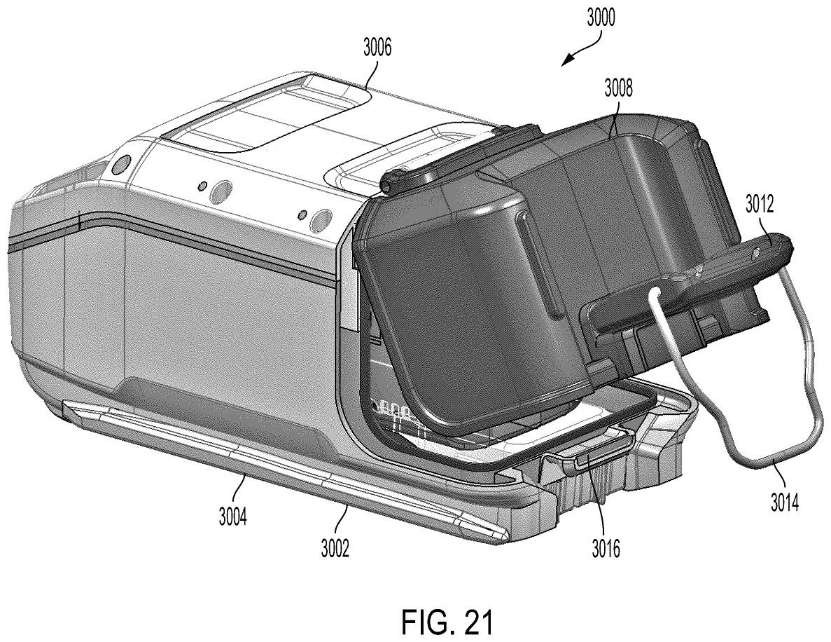

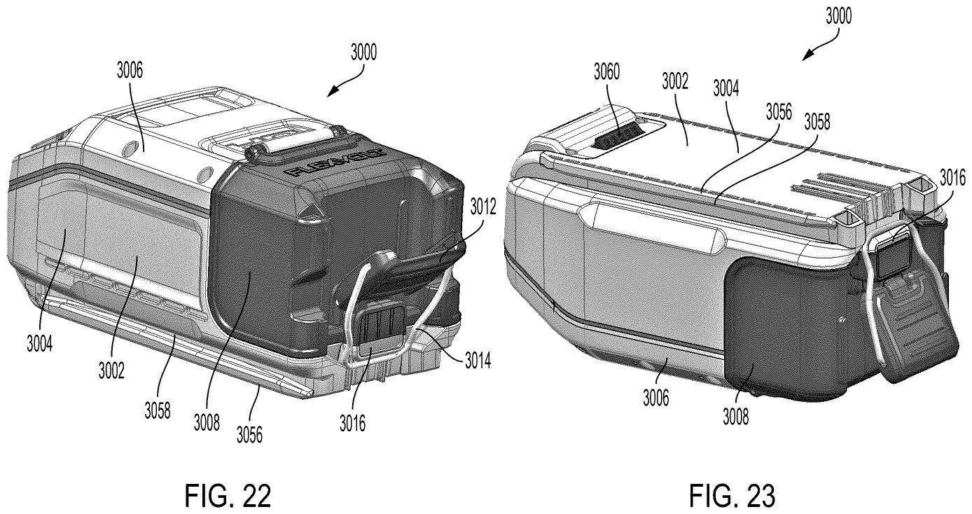

The door 3008 may be moved between the open position, the closed position, and one or more intermediate positions that are between the open and the closed positions. In the open position, the door 3008 may be configured to provide access to the cavity 3010 of the adaptor 3000 to either place/insert the battery pack 3100 in the cavity 3010 of the adaptor 3000 or remove the battery pack 3100 from the cavity 3010 of the adaptor 3000. In the closed position, the door 3008 may be configured to prevent access to the cavity 3010 of the adaptor 3000 and/or the battery pack 3100 positioned therein. The door 3008 may be moved between the closed position (as shown in FIGS. 22-26) and the open position (as shown in FIGS. 17-20), for example, using a hinge assembly/mechanism. FIG. 21 shows the battery pack 3100 received in the internal cavity 3010 of the housing 3002 and the door 3008 of the adaptor 3000 in an intermediate position of the door 3008 between the lowered, closed position and the raised, open position. The illustrated intermediate position is closer to the closed position of the door 3008. In one embodiment, a hinge assembly is designed to be installed on the door 3008. For example, a door hinge mechanism may be configured to mount the door 3008 for pivotal/swinging movement between at least the first (e.g., closed) and the second (e.g., open) positions. The pivoting door and the hinge mechanism for mounting them are well-known, and, therefore, are not described in detail here.

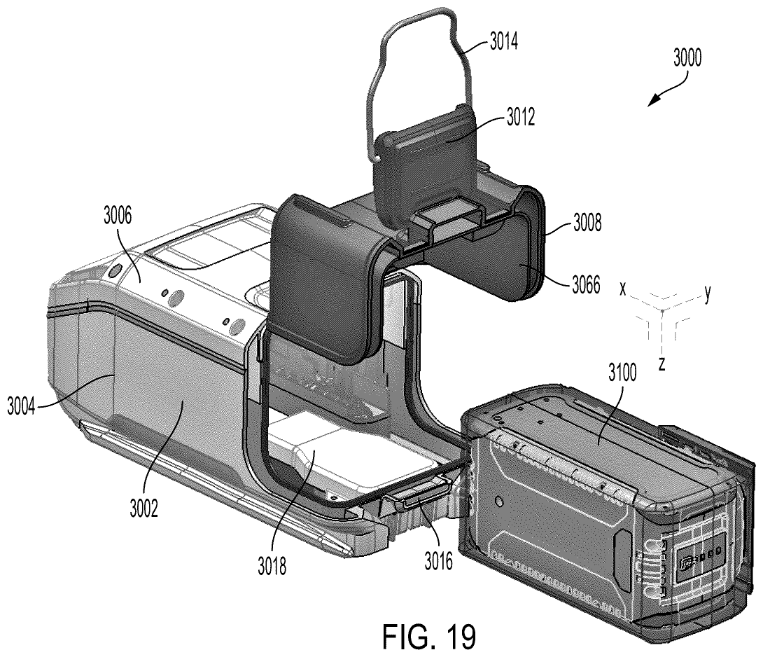

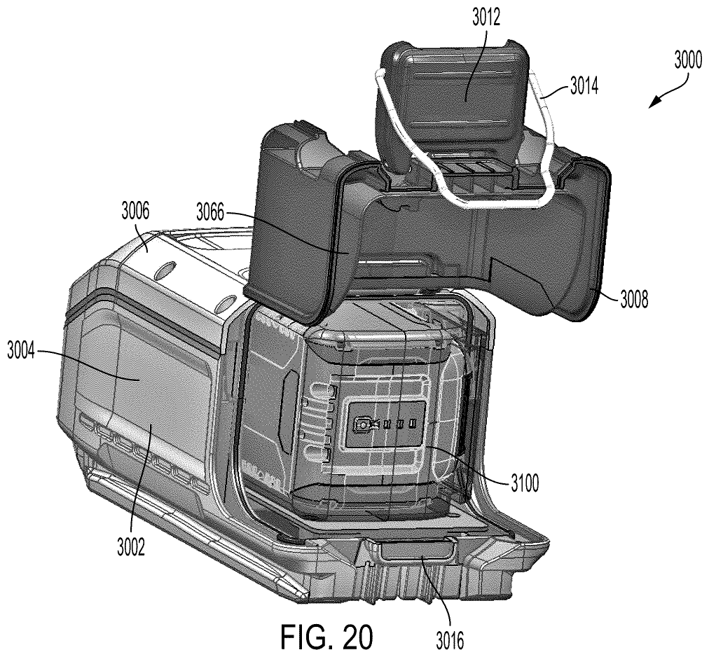

As shown in FIGS. 18-26, the adaptor 3000 may include a door latch that includes the actuation lever 3012 and the latch 3014 disposed on the door 3008 and the catch 3016 disposed on one of the housing portions 3004, 3006. In the illustrated embodiment, the catch/striker/receiver 3016 may be disposed on the first housing portion 3004 and the door 3008 may be pivotably connected to the second housing portion 3006. The latch 3014 may include a wire or a rod bent to form a loop. FIG. 18 shows that the door 3008, in its open position, with the actuation lever 3012 and the over center latch 3014. FIG. 18 also shows the adaptor 3000 without the battery pack 3100 received therein. FIG. 19 shows the battery pack 3100 being inserted into the internal cavity 3010 of the housing 3002. FIG. 20-21 shows the battery pack 3100 after it is inserted into the internal cavity 3010 of the housing 3002, where the door 3008 is in its open position in FIG. 20 and where the door 3008 is in its intermediate portion in FIG. 21. FIGS. 22-24 show the door 3008 in the closed position and the over center latch 3014 of the door being coupled to the catch 3016 of the housing 3002 to retain the door 3008 in the closed position. FIG. 24 also shows chamfers 3019 to push out the latch 3014 with the power tool terminal block 3065. The face/chamfer 3019 may be configured to interact with the power tool terminal block 3065 to push out the adapter 3000 when the latching system 3060 is compressed to remove the adapter 3000 from the tool.

The door latch (i.e., the actuation lever 3012, the latch 3014 and the catch 3016) may be configured to releasably connect the door 3008 to one of the first portion 3004 and the second portion 3006. The door latch may be configured to lock the door 3008 when the door 3008 is in its closed position. For example, the latch 3014 may be configured to engage with the catch 3016. The door latch may include a draw latch or a toggle latch that is generally characterized by having a component (e.g., latch 3014) under consistent tension. The door latch may provide strong closing forces to maintain seals against leaks and ingress of dust and water into the adaptor 3000. The door latch may also be designed to prevent accidental release of the latch 3014. The door latch is engaged when both the latch 3014 and the catch 3016 are engaged with each other under tension. The latch 3014 may be attached to the actuation lever 3012, for example, through a pin. Tension is created or released when the actuation lever 3012 is pushed or pulled. The actuation lever 3012 may be designed to produce a mechanical advantage so that sufficient tension can be created while requiring minimal actuation force for releasing the latch 3014. The door latch may include an over center latch. The over center latch includes an over center position/point. When the actuation lever 3012 is moved past its over center position, the latch 3014 becomes activated. At this point, the closing force is provided by the latch 3014 and the catch 3016.

The adaptor 3000 may include a potting boat or support member 3018 in the cavity 3010. The potting boat 3018 may be configured to support the battery pack 3100 in the cavity 3010 of the adaptor 3000. The battery pack 3100 may be positioned on its side as it is being received on the support member 3018. The side positioned configuration of the battery pack 3100 allows the battery pack terminals to engage with the terminals 3052 of an adaptor battery pack terminal block 3053 (as shown in FIG. 17-18) in the cavity 3010 of the adaptor 3000 when the battery pack 3100 is fully received in the adaptor 3000.

The housing 3002 of the adaptor 3000 may be configured to protect or store the battery pack 3100 from external shocks, separate from the housing of the battery pack 3100. The adaptor 3000 may include a pivot point 3036 for the door 3008. The pivot point 3036 may be provided on the housing 3002. The pivot point 3036 may be configured to lay flat against surface 3046 of the door 3008 or surface 3048 of the second housing portion 3006. The pivot point 3036 may be configured to be stored in a recess formed the surface 3046 of the door 3008 or the surface 3048 of the second housing portion 3006.

The adaptor 3000 may also include a handle 3038 that is integrally formed with the second housing portion 3006. The handle 3038 may include an inner wall 3040 defining an aperture 3042 between the second housing portion 3006 and the handle 3038. The aperture 3042 may be sized to receive a user's hand so that the user can grasp a grip portion 3044 of the handle 3038. The handle 3038 may be configured to enable a user to lift, carry or move the adaptor 3000 with or without the battery pack 3100 stored in the adaptor 3000.

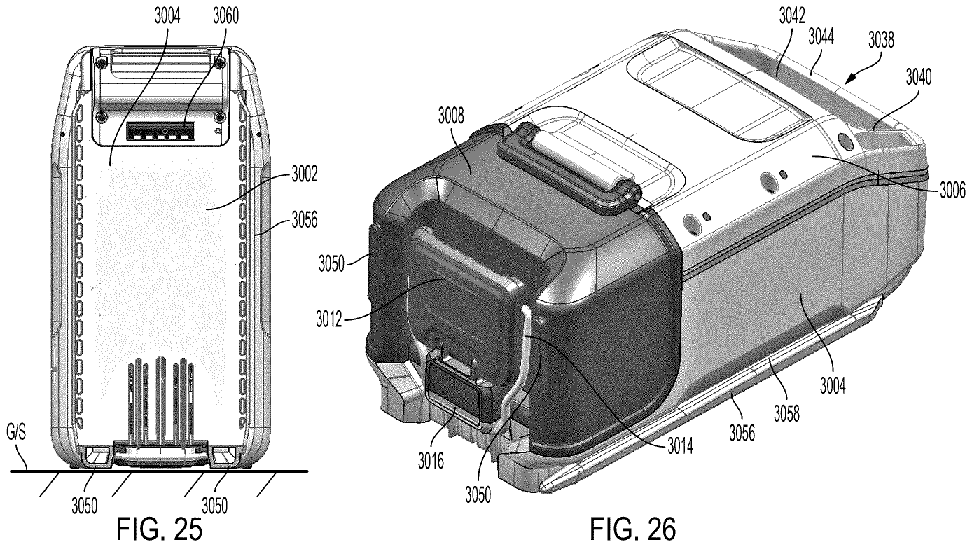

Referring to FIGS. 25-26, the adaptor 3000 may include a plurality of feet/support members 3050. The feet 3050 may be disposed on the door 3008 as shown in FIG. 26. The plurality of feet/support members 3050 may also be interchangeably referred to as the support base (i.e., in the form of feet-like protrusions on the door 3008). As shown in FIG. 25, the feet/support members 3050 may be configured to enable the adaptor 3000 to be supported or to stand on a surface S, such as the ground G, to avoid damage to the terminals 3064 of the adaptor tool terminal block 3065. For example, FIG. 25 shows the adaptor 3000 being positioned in a vertical configuration on the ground/surface G/S.

The adaptor 3000 may include the adaptor battery pack terminal block 3053 having a plurality of tool engaging terminals 3052 that are configured to engage with terminals of the battery pack 3100. The adaptor 3000 may be configured to receive the battery pack 3100 in the cavity 3010 therein. The battery pack 3100 may be configured to be placed (on its side) on the support member 3018 and slid into the cavity 3010 of the adaptor 3000. The battery pack 3100 may be configured to slide into the cavity 3010 of the adaptor 3000 until a latch system (having a first component disposed on the battery pack 3100 and a second components on the adaptor 3000) for fixing the battery pack 3100 to the adaptor 3000 is engaged, thus securing the battery pack 3100 to the adaptor 3000. The latch system may be optional. At the same time, electrical terminals/contacts of the battery pack 3100 may be configured to couple with electrical terminals/contacts 3052 in the adaptor 3000 to electrically couple the two components.

The adaptor 3000 may include the first set of electrical terminals 3052 that is connectable to the second set of electrical terminals of the battery pack 3100 so as to enable electrical connection between the battery pack 3100 and the adaptor 3000. The first set of electrical terminals 3052 may be disposed in the internal cavity 3010 of the housing 3002. The battery pack terminals may engage and mate with adaptor battery pack terminals 3052.

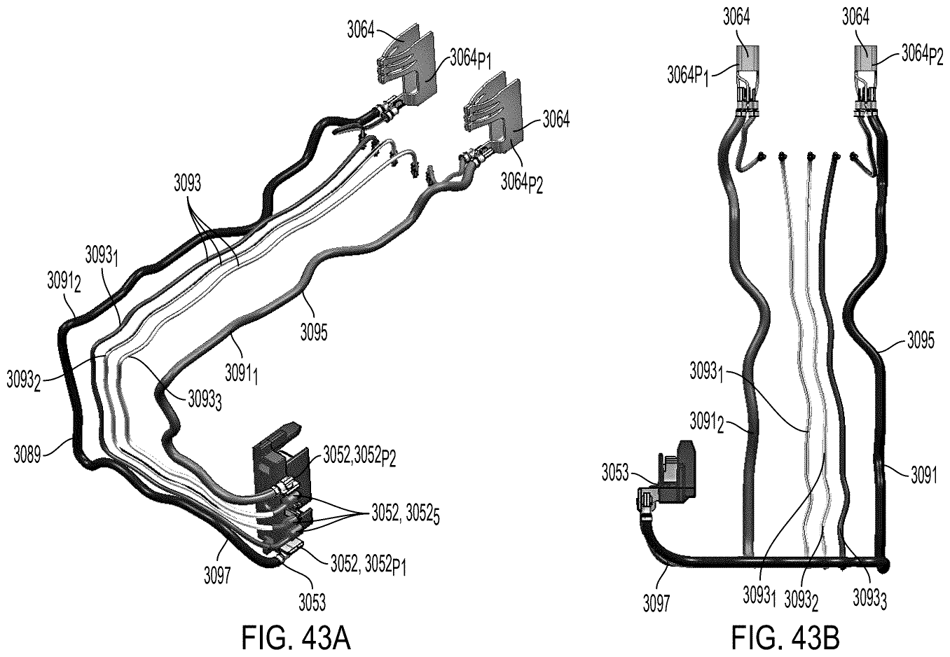

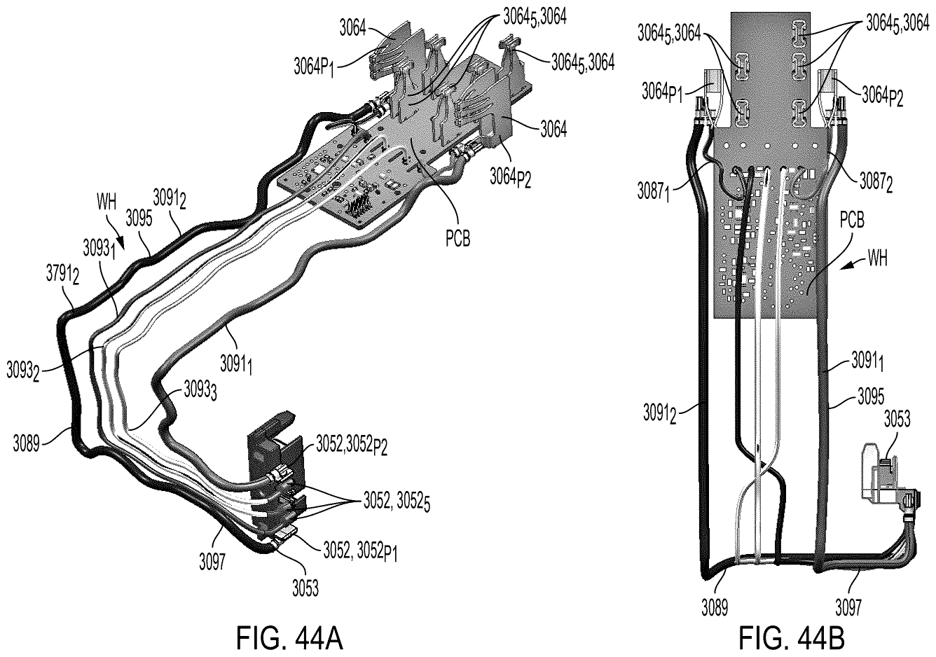

FIGS. 43A-43B show the first set of terminals 3052 of an adaptor battery pack terminal block 3053 that mates with terminals of the battery pack 3100 and terminals 3064 of an adaptor tool terminal block 3065 that mate with terminals of a power tool. At one end, power and signal wires of the wire harness WH are connected to the first set of terminals 3052 of the adaptor battery pack terminal block 3053 that mates with the terminals of the battery pack 3100. At the opposing end, the power wires of the wire harness are coupled to the power terminals 3064_{P} of the adaptor tool terminal block 3065 that mate with the power terminals of the power tool. FIGS. 44A-44B show the adaptor battery pack terminal block 3053, the power terminals 3064_{P} and the signal terminals 3064ₛ of the adaptor tool terminal block 3065, and a printed circuit board (PCB). The terminal ends (e.g., at the opposing end) of the signal wires of the wire harness WH and the signal terminals 3064ₛ of the adaptor tool terminal block 3065 are soldered to the PCB. Referring to FIGS. 43A-48B, the adaptor battery pack terminals 3052 may include adaptor battery pack power terminals 3052_{P} (two adaptor tool power terminals 3052_{P1} and 3052_{P2} are shown) and may include adaptor battery pack signal terminals 3052_{S} (three adaptor battery pack signal terminals 3052_{S} are shown). These adaptor battery pack terminals 3052 will be described in detail below.

The adaptor 3000 may include the adaptor tool terminal block 3065 having a plurality of tool engaging terminals 3064 that are configured to engage with terminals of a power tool. The housing 3002 of the adaptor 3000 may include a power tool interface 3054 (as shown in FIG. 4) configured for mechanically coupling with a corresponding battery pack interface (e.g., interface C) of an electrical device, for example, the HPHVPT or the HVC. The power tool interface 3054 of the adaptor 3000 may be disposed on the first housing portion 3004. The power tool interface 3054 of the adaptor 3000 may be designed to mimic the interface of a battery pack designed and configured to mate and operate with the power tool. The power tool interface 3054 of the adaptor 3000 may also include a rail and groove system including a pair of rails 3056 and a pair of grooves 3058. Other types of interfaces are contemplated and encompassed by the present patent application. The power tool interface 3054 of the adaptor 3000 may also include a latching system 3060 for fixing the battery pack adaptor 3000 to the HPHVPT or the HVC.

The housing 3002 of the adaptor 3000 may include a plurality of slots 3062 that correspond to a plurality of terminals of the electrical device (the HPHVPT or the HVC). The plurality of electrical device terminals may form a set of electrical device terminals. The electrical device terminals may be received by the battery adaptor terminal slots 3062 and engage and mate with adaptor tool terminals 3064. Referring to FIGS. 43A-48B, the adaptor tool terminals 3064 may include adaptor tool power terminals 3064_{P} (two adaptor tool power terminals 3064_{P1} and 3064_{P2} are shown) and may include adaptor tool signal terminals 3064_{S} (five adaptor tool power terminals 3064_{S} are shown). These adaptor battery pack terminals 3064 will be described in detail below.

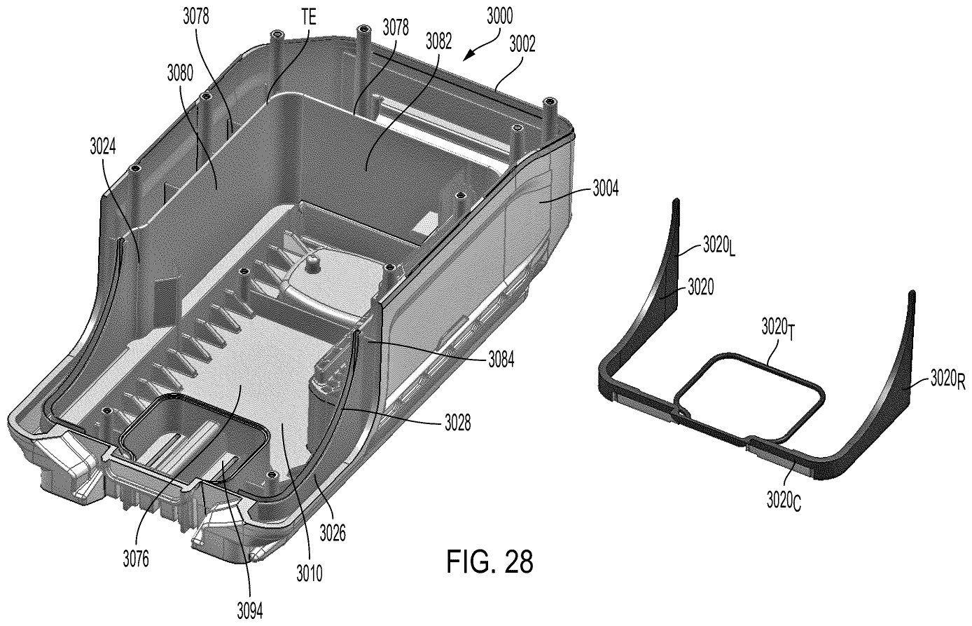

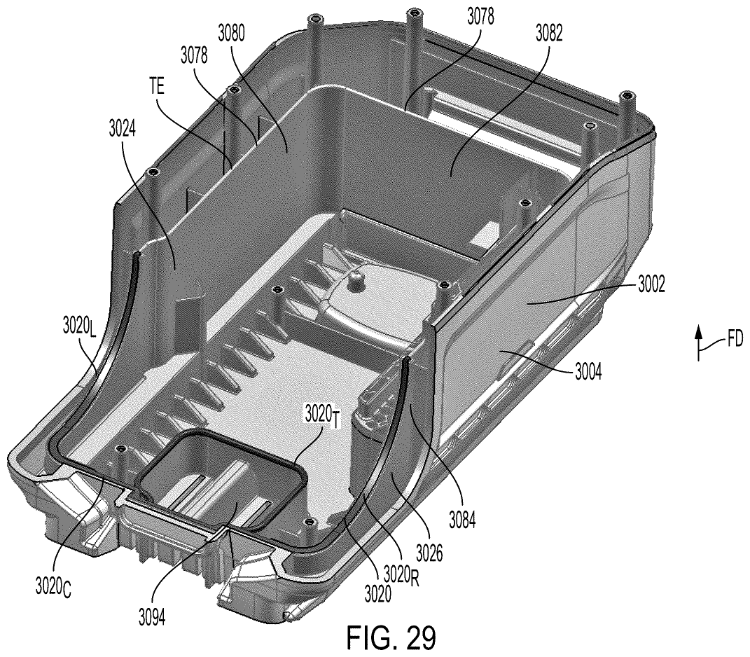

Referring to FIGS. 28-29, the first housing portion 3004 may include the inner wall 3024 and the outer wall 3026 in the internal cavity 3010. The first housing portion 3004 (including the inner wall 3024 and the outer wall 3026) is formed by a material having a first durometer. The first housing portion 3004 may also include a bottom wall 3076 connected to the inner wall 3024 and the outer wall 3026 in a U-shaped cross-sectional configuration with the pocket space 3028 formed between the inner and outer walls 3024, 3026. The inner wall 3024 and the outer wall 3026 may be formed of a high durometer material.

The first pocket space 3028 may be formed between the first portion outer wall 3026 and the first portion inner wall 3024 of the housing 3002. The first gasket 3020 may interchangeably referred to as a seal, an innermold or a seal member. The first gasket 3020 may be formed of a material having a second durometer.

The first gasket 3020 may include a first left gasket portion 3020_{L}, a first right gasket portion 3020_{R}, a first center gasket portion 3020_{C} and a first terminal gasket portion 3020_{T}. The first terminal gasket portion 3020_{T} may be configured to surround and seal the tool terminal portion 3094 of the adaptor 3000. The first left gasket portion 3020_{L}, the first right gasket portion 3020_{R}, and the first center gasket portion 3020_{C} may be configured to engage with the rib 3066 disposed/positioned on the door 3008 to form a sealed interface between the door 3008 and the first housing portion 3004 when the door 3008 is in its closed configuration.

The first housing portion 3004 may also include a rib/interlock wall/member 3078 (e.g., extending at least partially along two sides 3080, 3084 and completely along third side 3082 of the first housing portion 3004) that may be configured to engage with the gasket portions 3086 (e.g., extending along three sides 3088, 3090, 3092) of the second housing portion 3006 to form a sealed interface between the first and second housing portions 3004, 3006. The rib/interlock wall/member 3078 of the first housing portion 3004 may include the first durometer material. The gasket portions 3086 of the second housing portion 306 may include the second durometer material.

The first durometer material may be a hard durometer material. The first durometer material may be a high durometer material. The first durometer material may include glass filled nylon (GFN). The first durometer material may include polycarbonate (PC) material. The first durometer material may include Acrylonitrile Butadiene Styrene (ABS) material. The first durometer material may include a high/hard impact plastic material. The first (hard) durometer material may be any material that has a shore A durometer higher than the shore A durometer of the second durometer material. In one embodiment, the first durometer material may have a Shore A durometer of 80, while the second durometer material may have a Shore A durometer of 60. In another embodiment, the first durometer material may have a Shore A durometer of 60, while the second durometer material may have a Shore A durometer of 50.

The second durometer may be lower than the first durometer. The second durometer material may be a low durometer material. The second durometer material may be a soft durometer material. The second durometer material may include a thermoplastic elastomer (TPE) material. The second durometer material may include a rubber material.

The first gasket 3020 may be insert molded in the first pocket space 3028. The first gasket 3020 may be formed by a molding procedure, for example, an injection molding procedure in the first pocket space 3028 formed between the first portion inner wall 3024 and the first portion outer wall 3026.

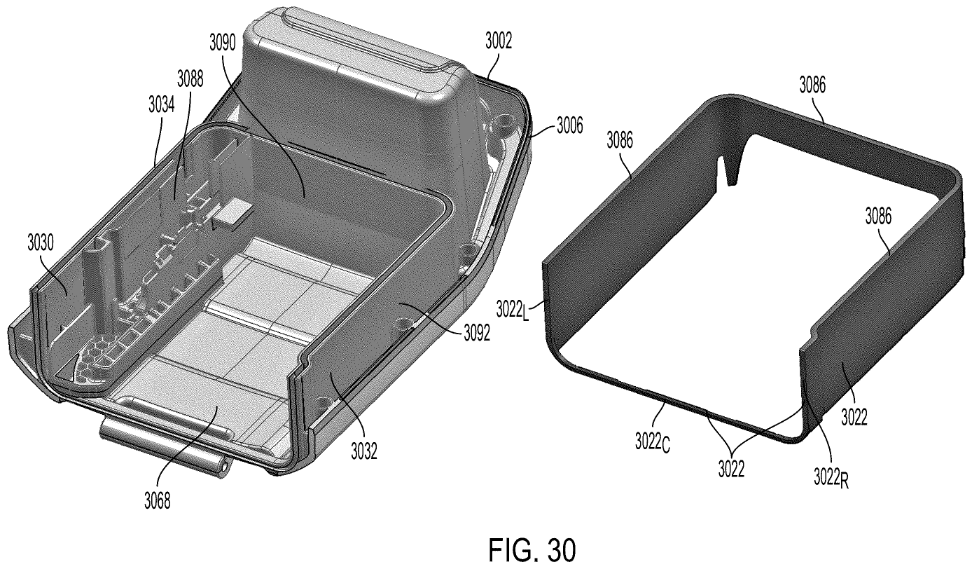

Referring to FIGS. 30-32, the second portion 3006 of the housing 3002 may include the inner wall 3030 and the outer wall 3032 in the internal cavity 3010. The second pocket space 3034 may be formed between the second portion outer wall 3032 and the second portion inner wall 3030. That is, the inner wall 3030 and the outer wall 3032 may at least in part define/form the second pocket space 3034. The pocket space may be interchangeably referred to as a pocket, a space, or a chamber. The second housing portion 3006 may also include a bottom wall 3068 connected to the inner wall 3030 and the outer wall 3032 in a U-shaped cross-sectional configuration with the pocket space 3034 formed between the inner and outer walls 3030, 3032. The inner wall 3030 and the outer wall 3032 may be formed of a high durometer material.

The second portion 3006 may include a seal assembly including the second gasket 3022 and its corresponding second pocket space 3034. As will be clear from the discussions below, the second gasket 3022 may include seal/gasket members 3022_{R}, 3022_{L}, 3022_{C}, and 3086. The second gasket 3022 may be formed by an injection molding process. The second gasket 3022 may be formed by an injection molding process of a low durometer material in the pocket/chamber/space 3034 of the seal assembly.

The second gasket 3022 may be formed of the material having the second durometer. The second gasket 3022 may be interchangeably referred to as a seal, an innermold or a seal member. The second gasket 3022 may be insert molded in the second pocket space 3034. The second gasket 3022 may be formed by a molding procedure, for example, an injection molding procedure in the second pocket space 3034 formed between the second portion inner wall 3030 and the second portion outer wall 3032.

The second gasket 3022 may include the second left gasket portion 3022_{L}, the second right gasket portion 3022_{R}, and the second center gasket portion 3022_{C}. The second left gasket portion 3022_{L}, the second right gasket portion 3022_{R}, and the second center gasket portion 3022_{C} may be configured to engage with the rib 3066 disposed/positioned on the door 3008 to form a sealed interface between the door 3008 and the second housing portion 3004 when the door 3008 is in its closed configuration.

The second gasket 3022 may also include the gasket portions 3086. The gasket portions 3086 extend along three sides 3088, 3090, 3092 of the second housing portion 3006 and engage with the rib/interlock wall/member 3078 of the first housing portion 3004 so as to form a sealed interface between the first and second housing portions 3004, 3006.

The innermold seal 3020, 3022 with a soft durometer seal may allow for the reduction of water and particulate ingress while being a permanent feature of the adaptor 3000. This may reduce part complexity while upholding the need for a seal for contamination ingress.

The second housing portion 3006 may be configured to be mated with first housing portion 3004 at a mating line ML. A seal may be formed between the first housing portion 3004 and the second housing portion 3006 at the mating line ML. One of the first housing portion 3004 and the second portion 3006 include the rib 3078 along at least a portion of the mating line ML and the other of the first housing portion 3004 and the second housing portion 3006 may include the injection molded gasket (i.e., gasket portions 3086) along at least a portion of the mating line ML. The rib 3078 may be interchangeably referred to as interlock element/wall.

In the illustrated embodiment, the rib 3066 of the door 3008 may be configured to engage the first gasket 3020 insert molded into the first pocket space 3028 of the first portion 3004 of the housing 3002 and engage the second gasket 3022 insert molded into the second pocket space 3034 of the second portion 3006 of the housing 3002.

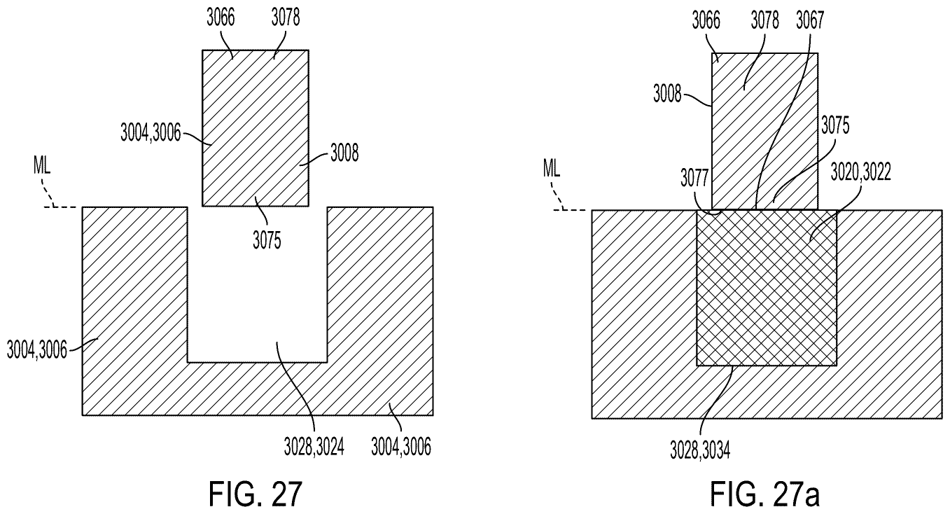

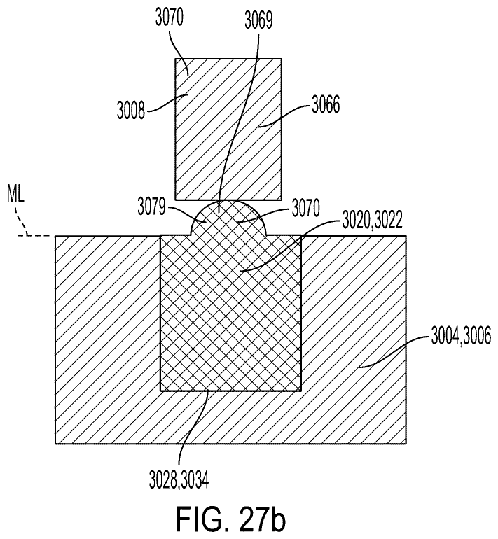

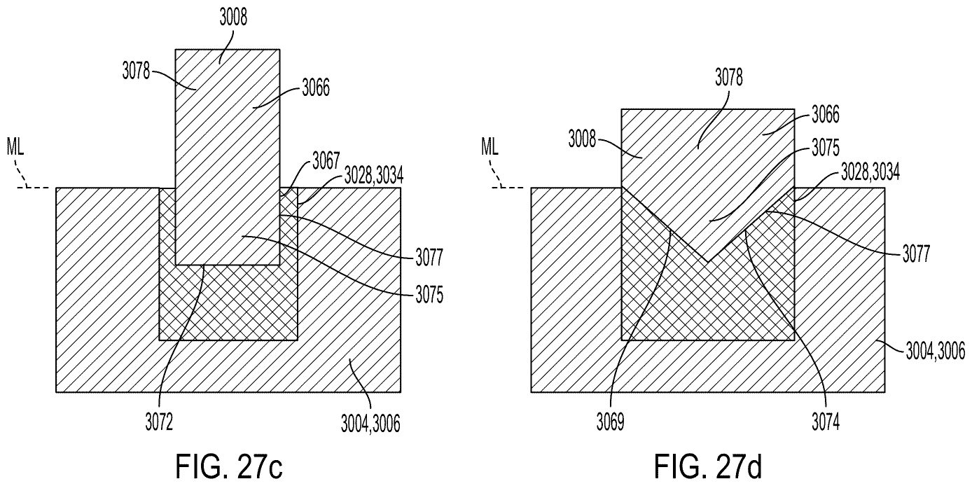

FIG. 27 shows the first housing portion 3004 and the second housing portion 3006 of the adaptor 3000 before a soft durometer material innermold/gasket 3020/3022 is received by one of the first housing portion 3004 and the second housing portion 3006 of the adaptor 3000. FIG. 27 shows the door 3008 and one of the first housing portion 3004 and the second housing portion 3006 of the adaptor 3000 before a soft durometer material innermold/gasket 3020/3022 is received by one of the first housing portion 3004 and the second housing portion 3006 of the adaptor 3000. That is, FIG. 27 shows two of the first, the second, and the third portions 3004, 3006, 3008 of the housing 3002 of the adaptor 3000 before receiving a material having the second durometer by at least one of the first housing portion 3004 and the second housing portion 3006 of the adaptor 3000. The first, the second, and the third portions 3004, 3006, 3008 of the housing 3002 of the adaptor 3000 may be made of a material having the first durometer.

FIGS. 27A-27D show schematic cross-sectional views of several embodiments of an innermold seal insert/gasket made from the material having the second durometer engaging with portions made of the material having the first durometer to provide a sealed interface between the first portion 3004 and the second portion 3006 of the housing 3002 of the adaptor 3000 or an innermold seal insert/gasket made from the material having the second durometer engaging with portions made of the material having the first durometer to provide a sealed interface between the third portion/door 3008 and at least one of the first portion 3004 and the second portion 3006 of the housing 3002 of the adaptor 3000.

The rib 3066 on the door 3008 or the rib 3078 on the second portion 3006 may include a gasket engaging portion 3075 having a cross-sectional configuration that is selected from the group consisting of a rectangular cross-sectional configuration, a square cross-sectional configuration, and a V-shaped cross-sectional configuration. The first gasket 3020 may include a geometry that is selected from the group consisting of a rectangular cross-sectional geometry, a square cross-sectional geometry, a V-shaped cross-sectional geometry, and a U-shaped cross-sectional geometry. The first gasket 3020 may include a first rib engaging surface 3077. The first gasket 3020 may include a first rounded rib engaging portion 3079.

The second gasket 3022 may include a geometry that is selected from the group consisting of a rectangular geometry, a square geometry, a rounded geometry, a V-shaped cross-sectional geometry, and a U-shaped cross-sectional geometry. The second gasket 3022 may include a second rib engaging surface 3067. The second gasket 3022 may include a second rounded rib engaging portion 3069 thereon.

In the embodiment of FIG. 27A, the gaskets 3020, 3022 in the housing portions 3004, 3006 may have a square or rectangular cross-sectional geometry. The rib/interlocking element/wall 3066 of the door 3008 or the rib 3078 of the housing portion may have a square or rectangular cross-sectional geometry.

In the embodiment of FIG. 27B, the gaskets 3020, 3022 in the housing portions 3004, 3006 may have a rounded protrusion 3070 that extends out of the pocket 3028, 3034. The rib/interlocking element/wall 3066 of the door 3008 or the rib 3078 of the housing portion may have a square or rectangular geometry.

In the embodiment of FIG. 27C, the gaskets 3020, 3022 in the housing portions 3004, 3006 may have a U-shaped geometry with a recess 3072 for receiving the rib 3066 of the door 3008 or the rib 3078 of the housing portion. The rib 3066 of the door 3008 or the rib 3078 of the housing portion may have a square or rectangular geometry.

In the embodiment of FIG. 27D, the gaskets 3020, 3022 in the housing portions 3004, 3006 may have a V-shaped geometry with a V-shaped recess 3074 for receiving the rib 3066 of the door 3008 or the rib 3078 of the housing portion. The rib 3066 of the door 3008 or the rib 3078 of the housing portion may have a V-shaped geometry.

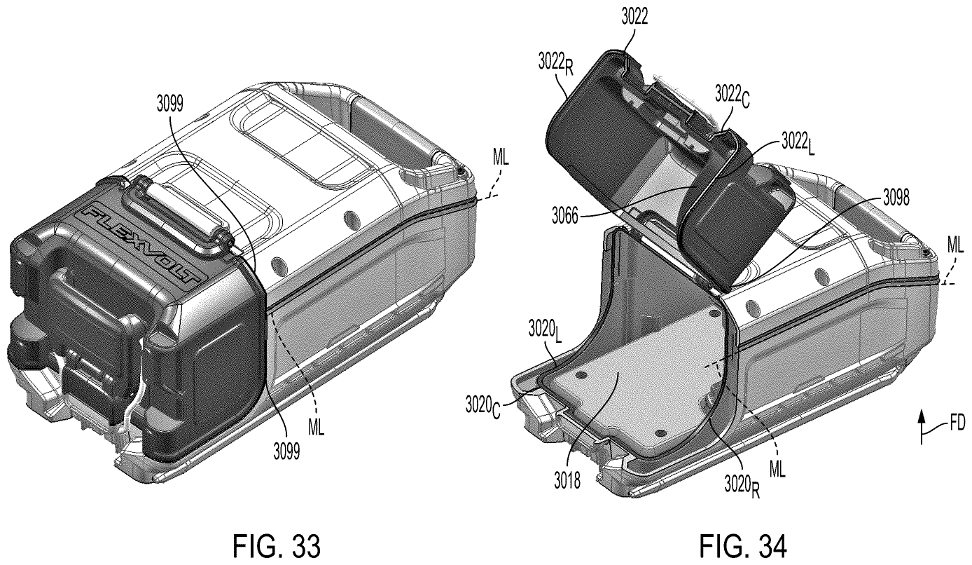

In the above discussions, the gasket positioned/disposed in one or both of the housing portions 3004, 3006 is being engaged with the rib disposed/formed on the door 3008 so as to form a sealed interface 3099 (as shown in FIG. 33) between the door 3008 and the housing portions 3004, 3006 when the door 3008 is in its closed position. Also, the gasket disposed in one of the housing portions may engage with the rib disposed/formed in the other of the housing portions so as to form a sealed interface between the housing portions 3004, 3006.

In yet another embodiment, the first housing portion 3004 may include the seal 3020 and also include seal portions extending along the sides 3080, 3082, and 3084. The seal portions along these sides of the first housing portion 3004 may be configured to engage with a rib formed on the housing portion 3006 so as to form a sealed interface between the housing portions 3004, 3006. In such an embodiment, the second housing portion 3006 may still include seal portions 3022_{L}, 3022_{C} and 3022_{R} that are configured to engage with the rib 3066 disposed on the door 3008 so as to form a sealed interface between the door 3008 and the housing portion 3006 when the door 3008 is in its closed position. As shown in FIGS. 33-34, the rib 3066 may be disposed on an inner cavity of the door 3008 and may be offset and parallel to the side walls of the door 3008.

As shown in FIGS. 28-29 and 33-34, the rib 3078 of the first portion 3004 may extend towards the second portion 3006 in a first direction FD and terminating in a terminal end TE at or generally about the mating line ML. The terminal end TE may include a different geometries. For example, as shown in and described with respect to FIGS. 27A-27D, the terminal end TE may include a square geometry, a rectangular geometry, V-shaped geometry or any other cross-sectional geometry as would be appreciated by a person of ordinary skill in the art.

The first housing portion 3004 may include the rib 3078 that is configured to fit within the boundary of the pocket space 3034. Received in at least a portion of the pocket space 3034 is the seal or gasket 3086 that is composed of a soft or low durometer material, such as rubber, a rubber-like materials, or a thermoplastic elastomer (TPE) material, to create a sealing face/interface between the first housing portion 3004 and the second housing portion 3006. The seal 3086 may be injection molded in between walls 3030, 3032 of the higher durometer material of the housing portion 3006 to hold the seal 3086 in place. When the first housing portion 3004 is coupled to the second housing portion 3006, the rib 3078 at least partially compresses the sealing face of the gasket 3086 to form a seal between the first and second housing portions 3004, 3006.

Referring to FIGS. 43A-48B, the adaptor 3000 may include a wire assembly having a wire harness WH. The wire assembly may also include the adaptor battery pack terminal block 3053 for the battery pack 3100 received/disposed in (the internal cavity 3010 of) the housing 3002 of the adaptor 3000. The terminals of the terminal block 3053 may include two power terminals 3052_{P1}-3052_{P2} (e.g., one power terminal for positive power terminal B+ of the battery pack 3100 and one power terminal for negative power terminal B− of the battery pack 3100) and the plurality of signal terminals 3052_{S} (e.g., three are shown in the illustrated embodiment wherein one signal terminal may be for a thermistor, one signal terminal may be for battery pack ID, and one signal terminal may be to monitor the voltage of some or all of the battery cells). The terminal block 3053 may be received inside the housing 3002 of the adaptor 3000 and may be configured to mate with the terminals of the battery pack 3100 received in the housing 3002. The battery pack 3100 received in the housing 3002, may be configured to be not directly attachable/connectable to the power tool either physically or electrically.

The wire assembly may also include the adaptor tool terminal block 3065 having the plurality of tool engaging terminals 3064 that are configured to engage with the terminals of the power tool. The adaptor tool terminal block 3065 may disposed within the housing 3002 of the adaptor 3000 so that its (power tool) terminals 3064 may pass through the housing 3002 of the adaptor 3000 and may be exposed, through a set of slots in the housing 3002, to outside the housing 3002 of the adaptor 3000 to enable the power tool terminals 3064 to engage the plurality of tool engaging terminals.

The wire harness WH may also include power wires 3091₁ and 3091₂ that may be configured to extend from the two power terminals 3052_{P1}-3052_{P2} and signal wires 3093 (e.g., 3093₁, 3093₂, 3093₃) that may extend from the three signal terminals 3052_{S}, The two power wires 3091₁ and 3091₂ and the three signal wires 3093₁, 3093₂, 3093₃ may all be in an L-shaped configuration having a long leg 3095 and a short leg 3097. The terminal block 3053 may be coupled to short leg 3097 of the L-shaped configuration of the wires. In one embodiment, the long leg 3095 of the L-shaped configuration of the wires may be positioned/disposed along a first plane and the short leg 3097 of the L-shaped configuration of the wires may be positioned/disposed along a second plane. The first plane and the second plane may be substantially perpendicular to each other. The wires in the second plane may also have an L-shaped configuration as shown in the illustrated embodiment. For example, the wires in the second plane may include a transition portion 3089 and the short leg 3097. The transition portion 3089 and the short leg 3097 may be positioned/disposed in the second plane and may be substantially perpendicular to each other.

Along the long leg 3095 of the L-shaped configuration of the wires, the power wires 3091₁ and 3091₂ may terminate in the pair of power terminals 3064_{P1} and 3064_{P2} that are coupled to the adaptor housing 3002 and that are configured to mate with power terminals in the power tool. Along the long leg 3095 of the L-shaped configuration of the wires, the signal wires 3093₁, 3093₂, 3093₃ may terminate in the plurality of signal terminals that are configured to mate with signal terminals in the power tool.

The present patent application provides a method of assembling a wiring assembly of an adaptor 3000. The adaptor includes the adaptor tool terminal block 3065 having the plurality of tool engaging terminals 3064 that are configured to engage with terminals of the power tool, the adaptor battery pack terminal block 3053 having the plurality of battery pack engaging terminals 3052 that are configured to engage with terminals of the battery pack. The wiring assembly may also include a printed circuit board PCB, a potting boat 3085, a potting material 3081, a terminal holder 3083, and the wire harness WH having the plurality of power wires 3091₁ and 3091₂ and the plurality of signal wires 3093₁, 3093₂, 3093₃. Each power wire 3091₁ and 3091₂ includes a first terminal end and a second terminal end. Each signal wire 3093₁, 3093₂, 3093₃ includes a first terminal end and a second terminal end. The plurality of battery pack engaging terminals 3052 of the adaptor battery pack terminal block 3053 includes power terminals and signal terminals. The plurality of tool engaging terminals 3064 of the adaptor tool terminal block 3065 includes power terminals and signal terminals.

The method comprises the steps of: (a) connecting the first terminal ends of the power wires 3091₁ and 3091₂ to the power terminals 3064_{P1} and 3064_{P2} of the adaptor tool terminal block 3065, (b) connecting the second terminal ends of the power wires 3091₁ and 3091₂ to the power terminals 3052_{P1} and 3052_{P2} of the adaptor battery pack terminal block 3053, (c) connecting the first terminal ends of the signal wires 3093₁, 3093₂, 3093₃ to the printed circuit board PCB, (d) connecting the second terminal ends of the signal wires 3093₁, 3093₂, 3093₃ to the signal terminals 3052_{S} of the adaptor battery pack terminal block 3053, (e) connecting the signal terminals 3064_{S} of the plurality of tool engaging terminals 3064 to the printed circuit board PCB, (f) disposing the wire harness WH, the adaptor tool terminal block 3065, and the adaptor battery pack terminal block 3053 in the potting boat 3085, (g) positioning the terminal holder 3083 over the power terminals 3064_{P1} and 3064_{P2} and the signal terminals 3064_{S} of the adaptor tool terminal block 3065, and (h) encapsulating the printed circuit board PCB, either partially or entirely, by the potting material 3081.

FIGS. 43A-48B illustrate assembly of the wire assembly of the adaptor 3000. At procedure/step 1, as shown in FIGS. 43A-43B, the wires (e.g., power wires 3091₁ and 3091₂) of the wire harness WH may be configured to be coupled to the power terminals 3052_{P1}-3052_{P2} of the terminal block 3053 at one terminal end and to the power terminals 3064_{P1} and 3064_{P2} that mate with the power tool at the other terminal end. The signal wires 3093₁, 3093₂, 3093₃ of the wire harness WH may be configured to be coupled to the terminal block 3053 at one terminal end and may be configured to be coupled to the PCB at the other terminal end.

At procedure/step 2, as shown in FIGS. 44A-44B, the signal wires 3093₁, 3093₂, 3093₃ of the wire harness WH may be configured to be coupled to the PCB at the other end. That is, the terminal ends of the signal wires 3093₁, 3093₂, 3093₃ may be soldered to the PCB. At procedure 2, the adaptor tool signal terminals 3064_{S} may also be soldered to the PCB.

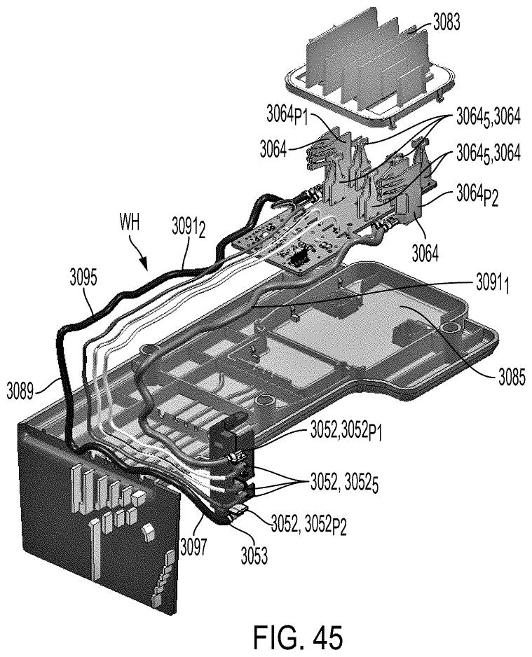

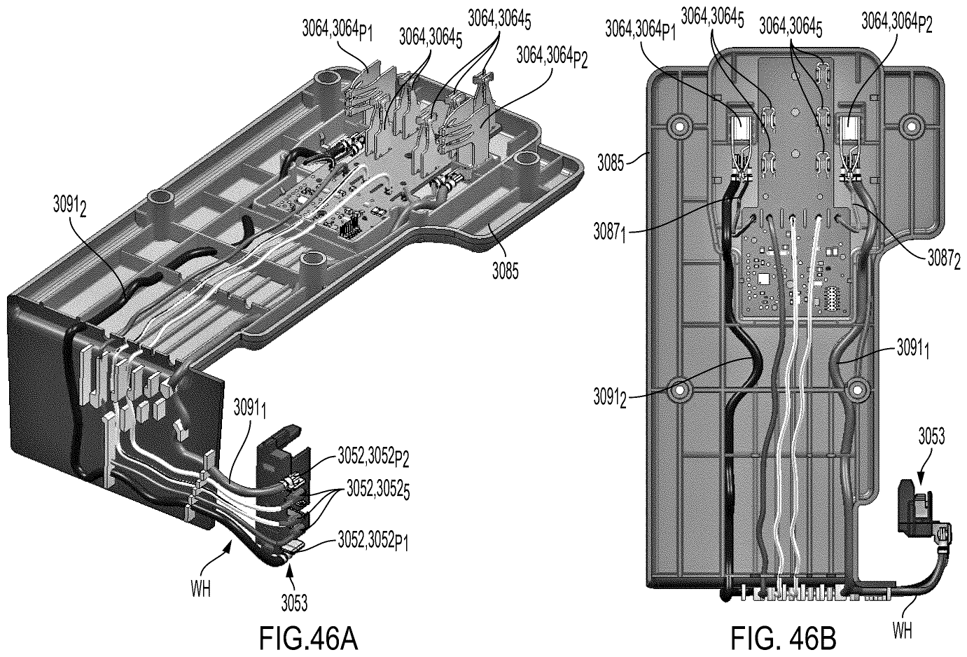

At procedure/step 3, as shown in FIGS. 45 and 46A-46B, the PCB, the power wires 3091 3091₂, the signal wires 3093₁, 3093₂, 3093₃, the adaptor tool signal terminals 3064_{S} on the PCB, the adaptor tool power terminals 3064_{P1} and 3064_{P2}, the adaptor battery pack power terminals 3052_{P1}-3052_{P2}, and the adaptor battery pack signal terminals 3052_{S} may all be received in the potting boat 3085.

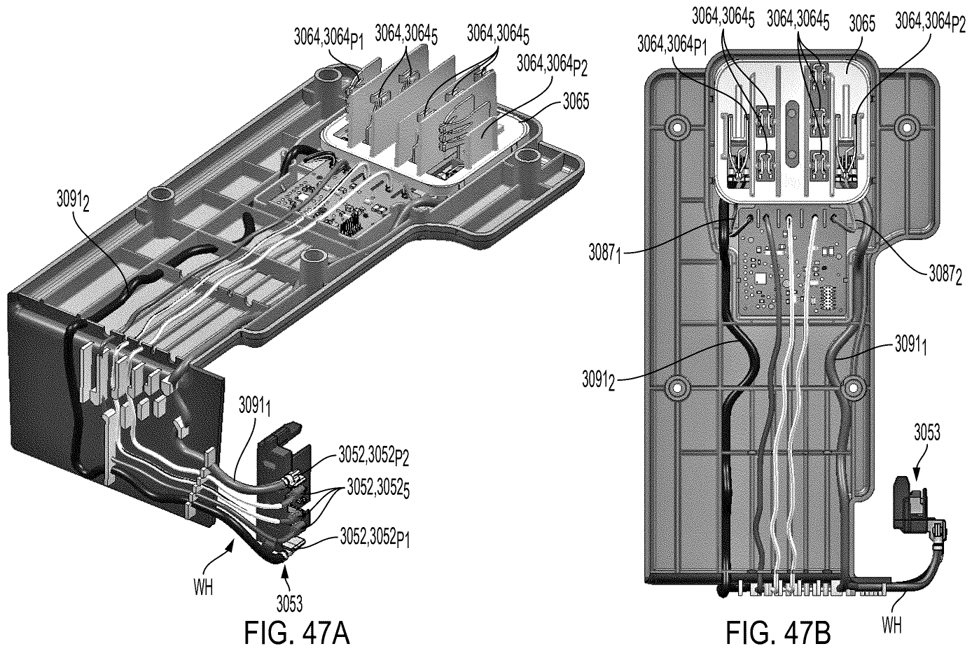

At procedure/step 4, as shown in FIGS. 45 and 47A-47B, a terminal holder (or PCB holder) 3083 may be positioned and installed over the adaptor tool signal terminals 3064_{S} and the adaptor tool power terminals 3064_{P1} and 3064_{P2}.

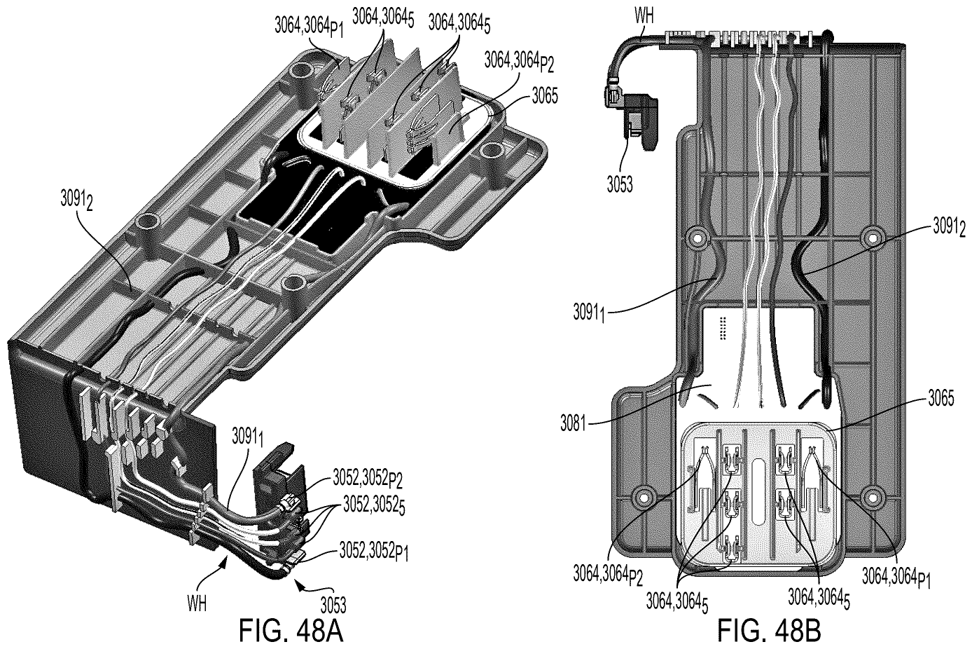

At procedure/step 5, as shown in FIGS. 48A-48B, potting material or compound 3081 may be added to the potting boat 3085 to replace a plastic terminal block housing so that no plastic material is used. The potting material/compound 3081 may be a thermal potting material/compound. This may make assembly more flexible and easier and may improve heat dissipation due to thermal properties of the potting compound.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. An adaptor, comprising:
a housing, the housing formed of a material having a first durometer and including a first portion and a second portion coupled to the first portion;
the housing including an internal cavity,
the first portion of the housing including an inner wall in the internal cavity and an outer wall in the internal cavity, a first pocket space formed between the first portion outer wall and the first portion inner wall;
a first gasket, the first gasket formed of a material having a second durometer, the second durometer being lower than the first durometer, the first gasket insert molded in the first pocket space;
the second portion of the housing including an inner wall in the internal cavity and an outer wall in the internal cavity, a second pocket space formed between the second portion outer wall and the second portion inner wall; and
a second gasket, the second gasket formed of the material having the second durometer, the second gasket insert molded in the second pocket space.

2. The adaptor of claim 1, wherein the first portion and the second portion form an opening to the internal cavity,
wherein the internal cavity is configured to receive a battery pack therein, and
wherein the housing includes a third portion to cover the opening to the internal cavity, the third portion including a rib configured to engage the first gasket and the second gasket to seal the internal cavity of the adaptor.

3. The adaptor of claim 1, wherein the material having the second durometer includes a material selected from the group consisting thermoplastic elastomer material and a rubber material.

4. The adaptor of claim 1, wherein the material having the first durometer includes a material selected from the group consisting of a glass filled nylon material, a polycarbonate material, and an Acrylonitrile Butadiene Styrene material.

5. The adaptor of claim 1, wherein the material having the second durometer includes a soft durometer material.

6. The adaptor of claim 1, wherein the material having the first durometer includes a hard durometer material.

7. The adaptor of claim 2, wherein the third portion is a door that is configured to be movably connected to one of the first and the second portions of the housing,
wherein the door includes an actuation lever with an over center latch that is configured to engage with a catch disposed on one of the first and the second portions of the housing so as to releasably connect the door to one of the first and the second portions of the housing.

8. The adaptor of claim 2, wherein the rib includes a gasket engaging portion having a cross-sectional configuration that is selected from the group consisting of a rectangular cross-sectional configuration, a square cross-sectional configuration, and a V-shaped cross-sectional configuration.

9. The adaptor of claim 1, wherein the first gasket includes a geometry that is selected from the group consisting of a rectangular cross-sectional geometry, a square cross-sectional geometry, a V-shaped cross-sectional geometry, and a U-shaped cross-sectional geometry.

10. The adaptor of claim 9, wherein the first gasket includes a first rib engaging surface.

11. The adaptor of claim 9, wherein the first gasket includes a first rounded rib engaging portion.

12. The adaptor of claim 1, wherein the second gasket includes a geometry that is selected from the group consisting of a rectangular geometry, a square geometry, a rounded geometry, a V-shaped cross-sectional geometry, and a U-shaped cross-sectional geometry.

13. The adaptor of claim 12, wherein the second gasket includes a second rib engaging surface.

14. The adaptor of claim 12, wherein the second gasket includes a second rounded rib engaging portion.

15. The adaptor of claim 2, wherein the adaptor includes an adaptor tool terminal block having a plurality of tool engaging terminals that are configured to engage with terminals of a power tool and an adaptor battery pack terminal block having a plurality of battery pack engaging terminals that are configured to engage with terminals of a battery pack,
wherein the adaptor tool terminal block is disposed within the housing,
wherein the adaptor battery pack terminal block is disposed in the internal cavity of the housing, and
wherein the battery pack is configured to be not directly attachable to the power tool either physically or electrically.

16. The adaptor of claim 1, wherein the adaptor includes an adaptor tool terminal block having a plurality of tool engaging terminals that are configured to engage with terminals of a power tool, an adaptor battery pack terminal block having a plurality of battery pack engaging terminals that are configured to engage with terminals of a battery pack, and a wire harness having a plurality of power wires and a plurality of signal wires,
wherein the plurality of battery pack engaging terminals of the adaptor battery pack terminal block includes power terminals and signal terminals,
wherein the plurality of tool engaging terminals of the adaptor tool terminal block includes power terminals and signal terminals,
wherein each power wire includes a first terminal end and a second terminal end, wherein the first terminal ends of the power wires are configured to be connected to the power terminals of the adaptor tool terminal block, and wherein the second terminal ends of the power wires are configured to be connected to the power terminals of the adaptor battery pack terminal block,
wherein each signal wire includes a first terminal end and a second terminal end, wherein the second terminal ends of the signal wires are configured to be connected to the signal terminals of the adaptor battery pack terminal block, and wherein the first terminal ends of the signal wires are configured to be connected to a printed circuit board, and
wherein the plurality of tool engaging terminals includes signal terminals that are connected to the printed circuit board.

17. The adaptor of claim 16, wherein the adaptor further comprises a potting boat, and wherein a portion of the wire harness and the adaptor tool terminal block are disposed in the potting boat.

18. The adaptor of claim 17, wherein the adaptor further comprises a terminal holder configured to be positioned over the power terminals and the signal terminals of the adaptor tool terminal block.

19. The adaptor of claim 18, wherein the printed circuit board and portions of the wire harness are encapsulated, either partially or entirely, by a potting material.

20. A method of assembling a wiring assembly of an adaptor, the adaptor includes an adaptor tool terminal block having a plurality of tool engaging terminals that are configured to engage with terminals of a power tool, an adaptor battery pack terminal block having a plurality of battery pack engaging terminals that are configured to engage with terminals of a battery pack, a printed circuit board, a potting boat, a potting material, a terminal holder, and a wire harness having a plurality of power wires and a plurality of signal wires, each power wire includes a first terminal end and a second terminal end, each signal wire includes a first terminal end and a second terminal end, the plurality of battery pack engaging terminals of the adaptor battery pack terminal block includes power terminals and signal terminals, the plurality of tool engaging terminals of the adaptor tool terminal block includes power terminals and signal terminals, the method comprising the steps of:
connecting the first terminal ends of the power wires to the power terminals of the adaptor tool terminal block,
connecting the second terminal ends of the power wires to the power terminals of the adaptor battery pack terminal block,
connecting the first terminal ends of the signal wires to the printed circuit board,
connecting the second terminal ends of the signal wires to the signal terminals of the adaptor battery pack terminal block,
connecting the signal terminals of the plurality of tool engaging terminals to the printed circuit board,
disposing the wire harness, the adaptor tool terminal block, and the adaptor battery pack terminal block in the potting boat,
positioning the terminal holder over the power terminals and the signal terminals of the adaptor tool terminal block, and
encapsulating the printed circuit board, either partially or entirely, by the potting material.
